(19) United States
(12) Patent Application Publication
(10) Pub. No.: US 2014/0216599 A1
(43) Pub. Date: Aug. 7, 2014

(54) HYDROGEN DISPENSER TEST APPARATUS AND METHOD

(71) Applicant: Canadian Standards Association Group, Toronto (CA)

(72) Inventor: Kenneth A. Loewenthal, Seven Hills, OH (US)

(21) Appl. No.: 14/174,075

(22) Filed: Feb. 6, 2014

Related U.S. Application Data
(60) Provisional application No. 61/762,091, filed on Feb. 7, 2013.
(60) Provisional application No. 61/779,345, filed on Mar. 13, 2013.

(51) Int. Cl. F17C 5/00; F17C 13/02

(52) U.S. Cl. CPC F17C 5/007; F17C 13/025
USPC 141/4; 141/197

(57) ABSTRACT

An apparatus and a method for testing a hydrogen dispenser is disclosed. The apparatus includes a first tank, a supply channel fluidly coupled to the first tank, the supply channel configured to be fluidly coupled to the hydrogen dispenser, a backpressure system fluidly coupled to the first tank, and a controller operatively coupled to the backpressure system. The controller is configured to receive a target fill profile, and control the backpressure system to effect a fill profile according to the target fill profile.

### CROSS-REFERENCE TO RELATED APPLICATIONS

This application claims priority to U.S. Provisional Patent Application No. 61/762,091, filed on Feb. 7, 2013, and U.S. Provisional Patent Application No. 61/779,345, filed on Mar. 13, 2013, the entire disclosures of which are hereby incorporated by reference.

### FIELD OF THE INVENTION

The invention relates generally to gaseous fuel distribution systems. More particularly, the invention relates to apparatus and methods for testing hydrogen distribution systems.

### BACKGROUND OF THE INVENTION

Apparatus and methods for distributing gaseous fuels, including hydrogen, have been proposed. For example U.S. Pat. No. 7,059,364 (hereinafter “the '364 patent”) describes a method and system for fueling hydrogen-fueled vehicles, including internal combustion engine and fuel cell powered vehicles. The algorithm used to control the fill process in the '364 patent determines the hydrogen storage vessel capacity of the vehicle being filled without the need for vehicle on-board instrumentation or communication between the vehicle and the hydrogen dispenser.

U.S. Pat. No. 7,568,507 (hereinafter “the '507 patent”) describes a system for delivering compressed gas to a receiving tank or vessel, and a diagnostic method and apparatus for shutting off the gas supply to the vessel if, during the fill cycle, the pressure of the gas in the vessel deviates by an undesired amount from the intended pressure at a desired ramp rate, where the ramp rate is a desired pressure increase in the fueling hose or line per unit time during the fill cycle.

U.S. Patent Application Publication No. 2009/0297897 describes a process for inhibiting leaks of hydrogen gas from an indoor hydrogen gas fueling system comprising monitoring the pressure of the hydrogen gas in a line leading to a hydrogen gas dispenser.

U.S. Patent Application Publication No. 2012/0104036 describes a compressed gas dispensing system having a programmable logic controller with a reference temperature that is compared to a measured ambient temperature, and the relationship between the two temperatures is utilized by the programmable logic controller to control the opening or sequencing of one or more flow control valves.

SAE TIR J2601, titled “Fueling Protocols for Light Duty Gaseous Hydrogen Surface Vehicles and Vehicle to Station Communications,” is an industry guideline intended to establish safety limits and performance requirements for gaseous hydrogen fuel dispensers. In part, SAE TIR J2601 tabulates average pressure ramp rate recommendations as a function of ambient temperature, initial tank pressure, and fueling target pressures. Further, SAE TIR J2601 defines a state of charge (SOC) for a tank as the ratio of hydrogen density within the vehicle storage system at instantaneous values of tank pressure and temperature to the full fill density evaluated at the nominal working pressure of the tank and a temperature of 15° Celsius.

However, none of the aforementioned references disclose apparatus or methods for testing the performance of hydrogen dispensers. Accordingly, it is desirable to provide apparatus and methods for testing hydrogen dispensers for safety, operability, and compliance with relevant industry standards, including standards for quantity of gas delivered and tank design limits, for example.

### SUMMARY

The foregoing needs are met, to a great extent, by the invention, wherein some embodiments are used to test hydrogen dispensers for safety, operability, and compliance with relevant industry standards, including standards for quantity of gas delivered and tank design limits, for example.

According to an aspect of the disclosure, an apparatus for testing a hydrogen dispenser includes a first tank, a supply channel fluidly coupled to the first tank, the supply channel configured to be fluidly coupled to the hydrogen dispenser, a backpressure system fluidly coupled to the first tank, and a controller operatively coupled to the backpressure system. The controller is configured to receive a target fill profile, and control the backpressure system to effect a fill profile according to the target fill profile.

Another aspect of the disclosure provides a method for testing a hydrogen dispenser using a test apparatus. The test apparatus includes a first tank, a supply channel fluidly coupled to the first tank, the supply channel configured to be coupled to the hydrogen dispenser, a backpressure system fluidly coupled to the first tank, and a controller operatively coupled to the backpressure system. The method includes receiving a target fill profile via the controller, dispensing hydrogen from the hydrogen dispenser to the test apparatus through the first valve, and controlling the backpressure system via the controller to effect a fill profile according to the target fill profile.

Another aspect of the disclosure provides an article of manufacture. The article of manufacture includes a machine-readable non-volatile medium having instructions encoded thereon for enabling a processor to perform the operations of dispensing hydrogen from a hydrogen dispenser to a first tank through a supply channel disposed between the hydrogen dispenser and the first tank, receiving a target fill profile, and controlling a backpressure system fluidly coupled to the first tank to effect a fill profile according to the target fill profile.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the Abstract, are for the purpose of description and should not be regarded as limiting.

As such, those skilled in the art will appreciate that the conception upon which this disclosure is based may readily be utilized as a basis for the designing of other structures, methods, and systems for carrying out the several purposes of the invention. Therefore, the claims should be regarded as including such equivalent constructions insofar as they do not depart from the spirit and scope of the invention.

### BRIEF DESCRIPTION OF THE DRAWINGS

FIG. 1 illustrates a schematic for a hydrogen dispenser test apparatus according to an embodiment of the invention.

FIG. 2 is a right side view of a tank inlet manifold according to an embodiment of the invention.

FIG. 3 illustrates a cross-sectional view of the tank inlet manifold along section 3-3 in FIG. 2.

FIG. 4 is a front view of a tank inlet manifold according to an embodiment of the invention.

FIG. 5 is a cross-sectional view of the tank inlet manifold along section 5-5 in FIG. 4.

FIG. 6 is a flowchart illustrating steps that may be followed in a hydrogen dispenser test apparatus main program according to an embodiment of the invention.

FIG. 7 is a flowchart illustrating steps that may be followed in an abort command test of a hydrogen dispenser test apparatus according to an embodiment of the invention.

FIG. 8 is a flowchart illustrating steps that may be followed in a halt command test of a hydrogen dispenser test apparatus according to an embodiment of the invention.

FIG. 9 is a flowchart illustrating steps that may be followed in a data loss and abort test of a hydrogen dispenser test apparatus according to an embodiment of the invention.

FIG. 10 is a flowchart illustrating steps that may be followed in a data loss and resumed fueling test of a hydrogen dispenser test apparatus according to an embodiment of the invention.

FIG. 11 is a flowchart illustrating steps that may be followed in a tank thermocouple communication fault test of a hydrogen dispenser test apparatus according to an embodiment of the invention.

FIG. 12 is a flowchart illustrating steps that may be followed in a leak detection at start of fueling test of a hydrogen dispenser test apparatus according to an embodiment of the invention.

FIG. 13 is a flowchart illustrating steps that may be followed in a leak during fueling test of a hydrogen dispenser test apparatus according to an embodiment of the invention.

FIG. 14 is a flowchart illustrating steps that may be followed in an initial tank overpressure test of a hydrogen dispenser test apparatus according to an embodiment of the invention.

FIG. 15 is a flowchart illustrating steps that may be followed in a first communication fill test of a hydrogen dispenser test apparatus including a first tank design according to an embodiment of the invention.

FIGS. 16A and 16B is a flowchart illustrating steps that may be followed in a first non-communication fill test of a hydrogen dispenser test apparatus including a first tank design according to an embodiment of the invention.

FIGS. 17A and 17B is a flowchart illustrating steps that may be followed in a second communication fill test of a hydrogen dispenser test apparatus including a second tank design according to an alternate embodiment of the invention.

FIG. 18 is a flowchart illustrating steps that may be followed in a second non-communication fill test of a hydrogen dispenser test apparatus including a second tank design according to an alternate embodiment of the invention.

FIGS. 19A and 19B is a flowchart illustrating steps that may be followed in a cold tank test of a hydrogen dispenser test apparatus according to an embodiment of the invention.

FIG. 20 illustrates an example of comparing a time history of pressure measurements to corresponding target pressure values according to an embodiment of the invention.

FIG. 21 is a flowchart illustrating steps that may be followed in a tank temperature compliance test during a filling cycle of a hydrogen dispenser test apparatus according to an embodiment of the invention.

FIG. 22 is a schematic illustrating a hydrogen dispenser test apparatus according to another embodiment of the invention.

FIG. 23 is a schematic illustrating a backpressure control system according to an embodiment of the invention.

FIG. 24 is a schematic illustrating a backpressure control system according to another embodiment of the invention.

FIG. 25 is a schematic illustrating a backpressure control system according to yet another embodiment of the invention.

FIG. 26 illustrates a target tank fill profile according to an embodiment of the invention.

FIG. 27 illustrates a target tank fill profile according to another embodiment of the invention.

FIG. 28 illustrates a target tank fill profile according to yet another embodiment of the invention.

### DETAILED DESCRIPTION

Various embodiments of the invention will now be described with reference to the drawing figures, in which like reference numerals refer to like parts throughout.

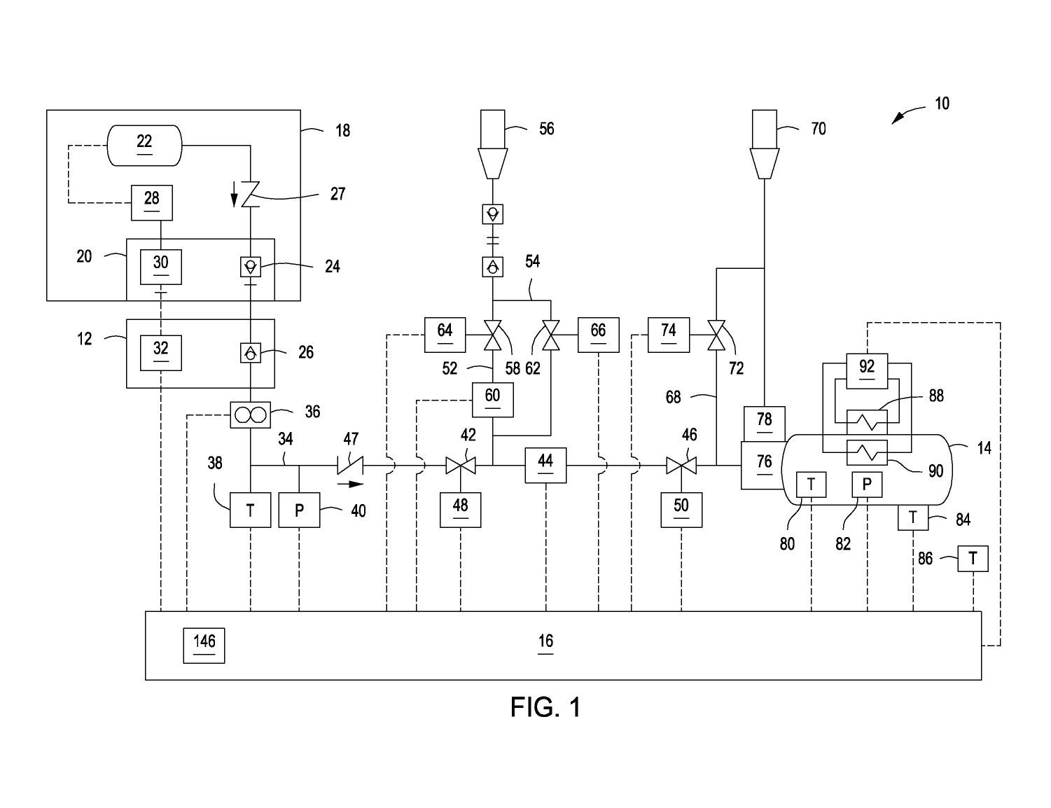

FIG. 1 illustrates a schematic for a hydrogen dispenser test apparatus 10 (HDTA) according to an embodiment of the invention. The HDTA 10 includes an HDTA receptacle 12 that is in fluid communication with a tank 14 and that is in electrical communication with an HDTA controller 16. The HDTA receptacle 12 is configured to couple the HDTA 10 to a hydrogen dispenser 18 through a dispenser receptacle 20.

In one embodiment, the hydrogen dispenser 18 includes a pressurized hydrogen storage system 22 in fluid communication with a dispenser fluid coupling 24 within the dispenser receptacle 20. Coupling the dispenser fluid coupling 24 with an HDTA fluid coupling 26 of the HDTA receptacle 12 effects fluid communication between the HDTA 10 and the hydrogen dispenser 18. The hydrogen dispenser 18 may include a check valve 27 disposed, for example, between the pressurized hydrogen storage system 22 and the dispenser fluid coupling 24 that allows flow only in a direction from the pressurized hydrogen storage system 22 to the dispenser fluid coupling 24.

The pressurized hydrogen storage system 22 may include, for example, storage tanks, hydrogen pumps or compressors, valves, heat exchangers, pressure sensors, temperature sensors, filters, or other fluid system components known to persons having skill in the art. Further, the pressurized hydrogen storage system 22 may be in electrical communication with the dispenser controller 28, such that the dispenser controller 28 at least partly controls operation of the pressurized hydrogen storage system 22. However, it will be appreciated that the hydrogen dispenser 18 could be any source for supplying pressurized hydrogen known to persons having skill in the art.

The dispenser fluid coupling 24 and the HDTA fluid coupling 26 may include any mating, detachable fittings that are known by persons having skill in the art to safely couple and seal hydrogen at pressures up to approximately 10,500 psi. In one advantageous embodiment of the invention the dispenser fluid coupling 24 and the HDTA fluid coupling 26 are quick-disconnect fittings such as WEH TK16/17 35/70 MPa Nozzle with or without data interface,¹ WEH TN1 35/70 MPa Receptacle,² or as specified by SAE J2600. 1 See http://www.weh.com/sites/default/files/tk17h2_{—}35mpa_ds_datenblatt-e_{—}02-12_{—}0.pdf, for example (last visited Feb. 3, 2013).2 See http://www.weh.com/sites/default/files/tn1_{—}70_e.pdf, for example (last visited Feb. 3, 2013).

The hydrogen dispenser 18 may further include a dispenser controller 28 in electrical communication with a dispenser data coupling 30, which may be located within the dispenser receptacle 20. Coupling the dispenser data coupling 30 with an HDTA data coupling 32 of the HDTA receptacle 12 enables data communication between the HDTA 10 and the hydrogen dispenser 18. The dispenser data coupling 30 and the HDTA data coupling 32 may include a wired or wireless connection, and may be configured to communicate an analog or a digital signal. Further, the dispenser controller 28 may transmit data to the HDTA controller 16, or vice-versa. In one advantageous embodiment of the invention the dispenser data coupling 30 and the HDTA data coupling 32 effect a wireless coupling between the hydrogen dispenser 18 and the HDTA 10 via transmission of infrared light by Infrared Data Association (IRDA). In another advantageous embodiment, the HDTA data coupling 32 includes an infrared transmitter and the dispenser data coupling 30 includes an infrared receiver.

Referring still to FIG. 1, the HDTA fluid coupling 26 is in fluid communication with the tank 14 through a supply channel 34. The supply channel 34 may include tubing, pipe, or any other fluid channel structure known to persons having skill in the art. The supply channel 34 may further include a flow meter 36 for measuring either a volumetric or gravimetric flow rate of fluid through the supply channel 34. In one advantageous embodiment, the flow meter 36 is a General Electric Rheonik Coriolis Mass Flow Meter, part number RHM04T1PHPHHHPA3AT. In another advantageous embodiment, the flow meter 36 is installed between the HDTA fluid coupling 26 and the dispenser fluid coupling 20 by providing the flow meter 36 with fittings complementary to the HDTA fluid coupling 26 and the dispenser fluid coupling 20.

Further, the supply channel 34 may include an HDTA inlet temperature sensor 38 and an HDTA inlet pressure sensor 40. The HDTA inlet temperature sensor 38 and the HDTA inlet pressure sensor 40 may be located advantageously close to the flow meter 36, such that the fluid pressure and temperature measured thereby are indicative of a pressure and a temperature of a fluid flowing through the flow meter 36. In another advantageous embodiment, the HDTA inlet temperature sensor 38 and the HDTA inlet pressure sensor 40 are located proximal to the HDTA fluid coupling 26, such that the fluid pressure and temperature measured thereby are indicative of a pressure and a temperature of fluid flowing through the HDTA fluid coupling 26. The flow meter 36, the HDTA inlet temperature sensor 38, and the HDTA inlet pressure sensor 40 may be in electronic communication with the HDTA controller 16 to receive electrical power from the HDTA controller 16, effect data communication with the HDTA controller 16, or combinations thereof, for example.

The supply channel 34 may further include a first supply isolation valve 42, first means for regulating a fluid flow 44, a second supply isolation valve 46, a check valve 47, or combinations thereof. The first supply isolation valve 42 and the second supply isolation valve 46 may be, for example, a gate valve, a globe valve, a ball valve, a diaphragm valve, or other valve design suitable for isolating a fluid flow known to persons having skill in the art. The first supply isolation valve 42 and the second supply isolation valve 46 may be manually operated, or they may include valve actuators 48, 50 that are controlled by the HDTA controller 16. Either of the valve actuators 48, 50 may be solenoid actuators, servomotor actuators, pneumatic actuators, hydraulic actuators, or other valve actuator known to persons having skill in the art. The check valve 47 may allow flow only in a direction from the hydrogen dispenser 18 toward the tank 14.

The first means for regulating a fluid flow 44 may include, for example, a fixed configuration flow restrictor such as an orifice plate or a nozzle, a manually-operated throttling valve or regulator, or an automatically-actuated throttling valve or regulator. Examples of throttling valves as the first means for regulating a fluid flow 44 include globe valves, butterfly valves, diaphragm valves, needle valves, plug valves, or other valve design suitable for throttling a fluid known to persons having skill in the art. Further, the first means for regulating a fluid flow 44 may be a regulator that acts to maintain a constant upstream pressure, a constant downstream pressure, or a constant flow rate therethrough, for example. The first means for regulating a fluid flow 44 may be in electrical communication with the HDTA controller 16 to receive electrical power, effect data communication with the HDTA controller 16, or combinations thereof, for example.

A first bleed channel 52 or a second bleed channel 54 may fluidly couple the supply channel 34 with a vent 56. In one advantageous embodiment, the first bleed channel 52 and the second bleed channel 54 are coupled to the supply channel 34 downstream of the first supply isolation valve 42 and upstream of the second supply isolation valve 46. However, it will be appreciated that the first bleed channel 52 and the second bleed channel 54 may be fluidly coupled to the supply channel 34 at any location along the supply channel 34. Further, the first bleed channel 52 may be coupled to the supply channel 34 at a location different from a location where the second bleed channel 54 is fluidly coupled to the supply channel 34.

The first bleed channel 52 and the second bleed channel 54 may include tubing, pipe, or any other fluid channel structure known to persons having skill in the art. The vent 56 may effect fluid communication with an ambient environment of the HDTA 10. Alternatively, the vent 56 may be a closed vessel configured to receive bleed flows from the supply channel 34, for example.

The first bleed channel 52 may include a first bleed isolation valve 58 and second means for regulating a fluid flow 60. The second means for regulating a fluid flow 60 may include, for example, a fixed configuration flow restrictor such as an orifice plate or a nozzle, a manually-operated throttling valve or regulator, or an automatically-actuated throttling valve or regulator. In one advantageous embodiment, the second means for regulating a fluid flow is a fixed orifice having a diameter between about 0.03 inches and about 0.06 inches. In another advantageous embodiment, the second means for regulating a fluid flow is a fixed orifice having a diameter between about 0.037 inches to about 0.041 inches.

Examples of throttling valves as the second means for regulating a fluid flow 60 include globe valves, butterfly valves, diaphragm valves, needle valves, plug valves, or other valve design suitable for throttling a fluid known to persons having skill in the art. Further, the second means for regulating a fluid flow 60 may be a regulator that acts to maintain a constant upstream pressure, a constant downstream pressure, or a constant flow rate therethrough, for example. The second means for regulating a fluid flow 60 may be in electrical communication with the HDTA controller 16 to receive electrical power, effect data communication with the HDTA controller 16, or both, for example.

The second bleed channel 54 may include a second bleed isolation valve 62. Either the first bleed isolation valve 58 or the second bleed isolation valve 62 may be, for example, a gate valve, a globe valve, a ball valve, a diaphragm valve, or other valve design suitable for isolating a fluid flow known to persons having skill in the art. The first bleed isolation valve 58 or the second bleed isolation valve 62 may be manually operated, or either may include valve actuators 64, 66 that are controlled by the HDTA controller 16. Either of the valve actuators 64, 66 may be a solenoid actuator, a servomotor actuator, a pneumatic actuator, a hydraulic actuator, or other valve actuator known to persons having skill in the art.

A vent channel 68 may fluidly couple the supply channel 34 with a vent 70. In one advantageous embodiment, the vent channel 68 is coupled to the supply channel 34 downstream of the second supply isolation valve 46 and upstream of the tank 14. However, it will be appreciated that the vent channel 68 may couple to the supply channel 34 at any location along the supply channel 34. The vent channel 68 may include tubing, pipe, or any other fluid channel structure known to persons having skill in the art. The vent 70 effects fluid communication with an ambient environment of the HDTA 10.

The vent channel 68 includes a vent isolation valve 72. The vent isolation valve 72 may be, for example, a gate valve, a globe valve, a ball valve, a diaphragm valve, or other valve design suitable for isolating a fluid flow known to persons having skill in the art. The vent isolation valve 72 may be manually operated, or may include a valve actuator 74 that is controlled by the HDTA controller 16. The valve actuator 74 may be a solenoid actuator, a servomotor actuator, a pneumatic actuator, a hydraulic actuator, or other valve actuator known to persons having skill in the art.

The supply channel 34 is fluidly coupled to the tank 14 via a tank inlet manifold 76, which simulates the function of a multipurpose, in-cylinder, automotive valve block. The tank inlet manifold 76 may also provide a connection for a pressure relief device 78. The pressure relief device may be a temperature-actuated pressure relief device (TPRD) or a pressure-actuated pressure relief device (PRD). A TPRD includes a valve actuated on the basis of a measured temperature. When a temperature sensed by a TPRD exceeds a threshold temperature, the TPRD valve opens, thereby relieving pressure within the tank 14 by effecting fluid communication between the tank 14 and the ambient environment of the HDTA 10 via the vent 70, for example. A PRD may include, for example, a burst disc or a pressure relief valve that effects fluid communication between the tank 14 and the ambient environment of the HDTA 10 via the vent 70 when an internal pressure within the tank 14 exceeds a threshold value.

It will be appreciated that the tank 14 may embody a wide range of capacities and constructions. In an embodiment of the invention, the tank 14 is a type III hydrogen gas vehicle fuel tank having a design pressure rating of 10,152 psig (70 MPa), a metal liner, a nominal water volume of about 2,441 cubic inches (40 liters), an outer diameter of about 13 inches (329 mm), and containing about 3.5 lbm (1.6 kg) of hydrogen at 100% state of charge when fueled at a 70 MPa hydrogen dispenser (hereinafter “Test Tank A”). In another embodiment of the invention, the tank 14 is a type IV hydrogen gas vehicle fuel tank having a design pressure rating of 10,152 psig (70 MPa), a polymer liner, a nominal water volume of about 9,398 cubic inches (154 liters), and an outer diameter of about 22 inches (507 mm) (hereinafter “Test Tank B”). In yet another embodiment of the invention, the tank 14 is a type IV hydrogen gas vehicle fuel tank having a design pressure rating of 10,152 psig (70 MPa), a polymer liner, a nominal water volume of about 15,195 cubic inches (249 liters), and an outer diameter of about 22 inches (507 mm) (hereinafter “Test Tank C”). However, it will be appreciated that the tank 14 may embody any advantageous tank design.

The tank 14 may include instrumentation including, but not limited to, a tank internal temperature sensor 80, a tank internal pressure sensor 82, a tank external surface temperature sensor 84, or combinations thereof, for example. The tank internal temperature sensor 80 and the tank internal pressure sensor 82 may be coupled to the tank 14 through access ports in the tank inlet manifold 76, or via access ports through the tank 14. Further, the HDTA may include an ambient temperature sensor 86 that measures a temperature of the ambient environment around the HDTA 10. The tank internal temperature sensor 80, the tank internal pressure sensor 82, the tank external surface temperature sensor 84, and the ambient temperature sensor 86 may be in electrical communication with the HDTA controller 16, such that any of these instruments receive power from the HDTA controller 16, send or receive data with the HDTA controller 16, or combinations thereof.

The tank 14 may include an external heater 88, an internal heater 90, or both. The external heater 88 is disposed on an outer surface of the tank 14, and the internal heater 90 is disposed within the tank 14. Further, a heating element of the internal heater 90 may or may not be in contact with an inner surface of the tank 14. In one advantageous embodiment, the external heater 88 and the internal heater 90 are electrical resistance heaters that receive electrical power from the heater power supply 92. The heater power supply may operate according to manual set points, or may be in electrical communication with the HDTA controller 16 such that the HDTA controller 16 controls the heater power supply 92.

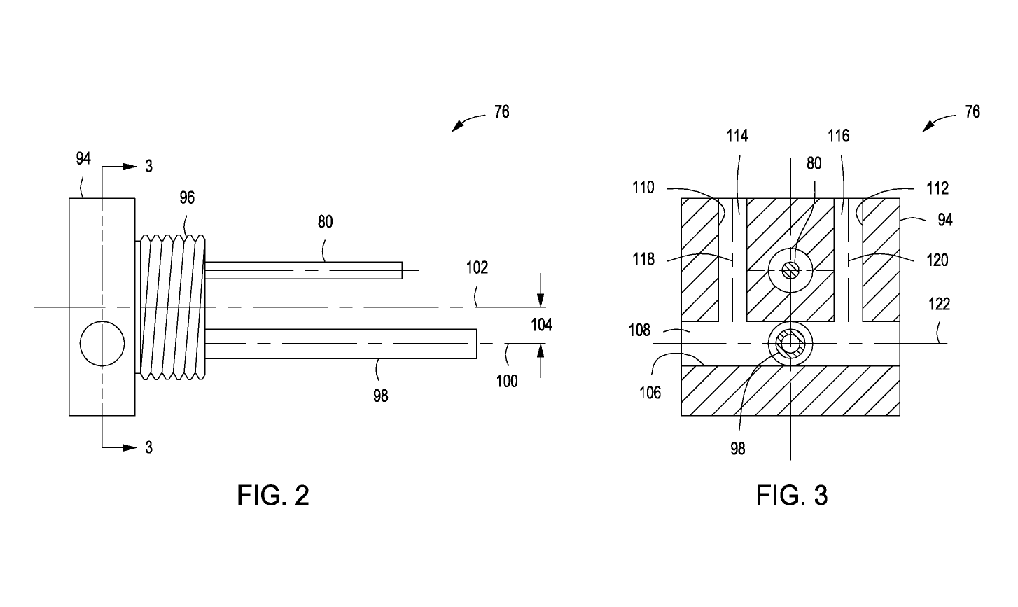

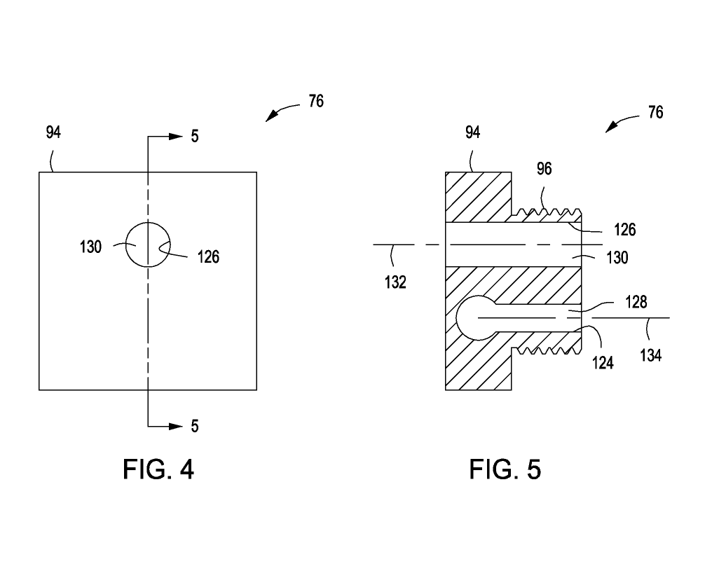

Referring now to FIGS. 2-5, it will be appreciated that FIG. 2 shows a right side view of the tank inlet manifold 76 according to an embodiment of the invention; FIG. 3 provides a front cross sectional view along section 3-3 of the tank inlet manifold 76 of FIG. 2; FIG. 4 shows a front view of the tank inlet manifold 76 according to an embodiment of the invention; and FIG. 5 provides a right side cross sectional view along section 5-5 of the tank inlet manifold 76 of FIG. 4.

As shown in FIG. 2 the tank inlet manifold includes a block 94 having a threaded portion 96 configured to engage threads (not shown) on the tank 14. A fill tube 98 may project from the threaded portion 96 of the block 94. In an advantageous embodiment, a longitudinal axis 100 of the fill tube 98 is substantially parallel to a longitudinal axis 102 of the threaded portion 96. In another advantageous embodiment, the longitudinal axis 100 of the fill tube 98 is substantially parallel to and spaced apart from the longitudinal axis 102 of the threaded portion by a distance 104, thereby advantageously enhancing mixing of fluid entering the tank 14 through the fill tube 98 with fluid already contained within the tank 14. Further, the tank internal temperature sensor 80 may be coupled to the tank inlet manifold 76 and project into the tank 14 away from the tank inlet manifold 76.

As shown in FIG. 3, the tank inlet manifold 76 includes a first internal surface 106 defining a first bore 108 within the block 94. The first bore 108 may extend from one side of the block 94 to an opposite side of the block 94, such that the first internal surface 106 defines apertures on opposite sides of the block 94. Alternatively, the first bore 108 may extend through only one side of the block 94, such that the first internal surface 106 defines an aperture on only one side of the tank inlet manifold 76.

The tank inlet manifold 76 further includes a second internal surface 110 and a third internal surface 112 defining a second bore 114 and a third bore 116, respectively. The second bore 114 and the third bore 116 intersect the first bore 108, thereby establishing fluid communication between the first bore 108, the second bore 114, and the third bore 116. In one embodiment of the invention, the second bore 114 and the third bore 116 project through a same side of the block 94, such that a longitudinal axis 118 of the second bore 114 is substantially parallel to a longitudinal axis 120 of the third bore 116. In another embodiment of the invention, the longitudinal axis 118 of the second bore 114 and the longitudinal axis 120 of the third bore 116 are substantially perpendicular to a longitudinal axis 122 of the first bore 108.

Referring now to FIGS. 4 and 5, the tank inlet manifold 76 may further include a fourth internal surface 124 and a fifth internal surface 126 defining a fourth bore 128 and a fifth bore 130, respectively. The fourth bore 128 extends through a face of the threaded portion 96 and intersects the first bore 108 within the block 94, thereby effecting fluid communication between the first bore 108 and the fourth bore 128. Further, the fill tube 98 (FIG. 2) is in fluid communication with the fourth bore 128, and may be disposed at least partly within the fourth bore 128. The fifth bore 130 may extend through a face of the threaded portion 96 and through the block 94, such that a tank internal temperature sensor 80 (FIG. 2) may be inserted through one side of the block 94 and extend through the face of the threaded portion 96.

In an advantageous embodiment of the invention, a longitudinal axis 132 of the fifth bore 130 is substantially parallel to a longitudinal axis 134 of the fourth bore 128. In another advantageous embodiment of the invention, the longitudinal axis 132 of the fifth bore 130 and the longitudinal axis 134 of the fourth bore 128 are both substantially perpendicular to the longitudinal axis 122 of the first bore, the longitudinal axis 118 of the second bore 114, and the longitudinal axis 120 of the third bore.

In an advantageous embodiment of the invention, the supply channel 34 (FIG. 1) is fluidly coupled to a first aperture of the first bore 108, and a first pressure relief device 78a, which is a TPRD, is fluidly coupled to a second aperture of the first bore 108. Further, the tank internal pressure sensor 82 may be fluidly coupled to an aperture of the second bore 114, and a second pressure relief device 78b, which is a PRD, may be fluidly coupled to an aperture of the third bore 116.

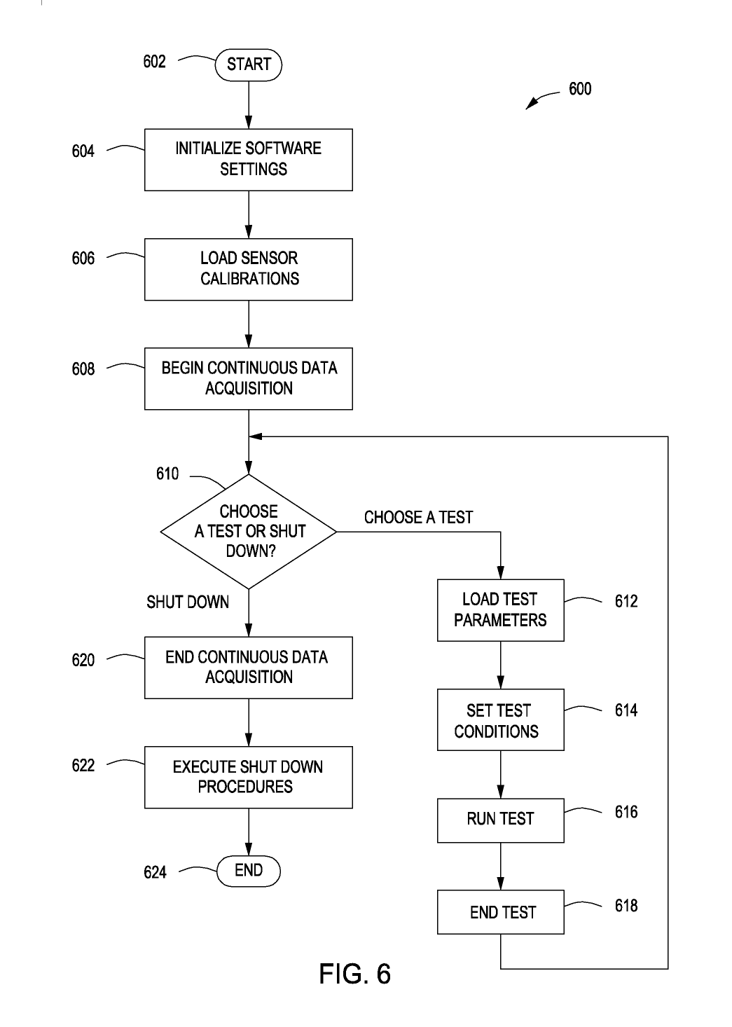

Operation of the HDTA 10 may be controlled by an algorithm run on the HDTA controller 16. FIG. 6 shows a flowchart for the HDTA main program 600, according to an embodiment of the invention.

The HDTA main program 600 starts at step 602 by executing, for example, a set of machine-readable instructions stored on non-volatile memory medium. The non-volatile memory medium may include, for example, a hard disk drive internal or external to the HDTA controller 16, a magnetic or optical disc read by the HDTA controller 16 using an internal or external disc drive, a USB flash drive, a virtual drive located on a local area network (LAN) or the Internet, or other similar non-volatile memory media known to persons having skill in the art.

Next, the HDTA main program 600 proceeds to step 604 where software settings are initialized. Initialization of software settings during step 604 may include, loading software, initializing program start-up settings, or initializing safety checks, for example. Then, the HDTA program proceeds to step 606 where sensor calibrations are loaded. During step 606 sensor calibrations may be loaded from the same non-volatile memory where the machine-readable instructions for the HDTA main program 600 are stored, or alternatively, from another similar non-volatile memory. During step 606, calibration data may be loaded for any of the various pressure sensors, temperature sensors, flowmeters, or any other instruments included in the HDTA 10 that utilize calibration data.

Next, continuous data acquisition begins at step 608, such that the HDTA controller 16 acquires signals from devices in data communication with the HDTA controller 16. The HDTA controller may perform mathematical or logical operations on the signals acquired, and store the raw signals, calculated values, or both to volatile or non-volatile memory in data communication with the HDTA controller 16.

At step 610, a user of the HDTA 10 is given the option to either choose a test to run using the HDTA 10 or shutdown the HDTA main program 600. The HDTA main program may present the user with a menu containing a plurality of possible tests that may be chosen at step 610, as will be discussed below. The user may input her choice into the HDTA controller 16 using a mouse, keyboard, touch screen, voice command, or other input device known to persons having skill in the art.

If the user chooses to run a test, then the HDTA main program 600 proceeds to step 612 where parameters specific to the chosen test are loaded into the HDTA controller 16. Such parameters may include executable machine-readable instructions, threshold values, success/failure criteria, combinations thereof, or other test parameters known to persons having skill in the art.

Next, the HDTA main program 600 sets test conditions within the HDTA 10. Test conditions may be set by operating any of the valves or heaters, performing calculations based on signals acquired by the HDTA main program 600, or combinations thereof. Once test conditions of the HDTA 10 are set, the HDTA main program 600 runs the test chosen in step 601. Running a test may include, for example, operating any of the valves or heaters in the HDTA 10, acquiring data, performing calculations, or combinations thereof. At the completion of the test in step 618, the HDTA main program returns to step 610.

If the user chooses to shutdown the HDTA main program 600 at step 610, the continuous data acquisition is ended at step 620. Next, shutdown procedures are executed in step 622. The shutdown procedures may include, for example, saving acquired signals, calculated values, or both, to non-volatile memory in data communication with the HDTA controller 16; isolating electrical power from either the external heater 88 or the internal heater 90; venting identified pressurized volumes within the HDTA 10; closing valves within the HDTA 10; or combinations thereof. Finally, the HDTA main program ends at step 624.

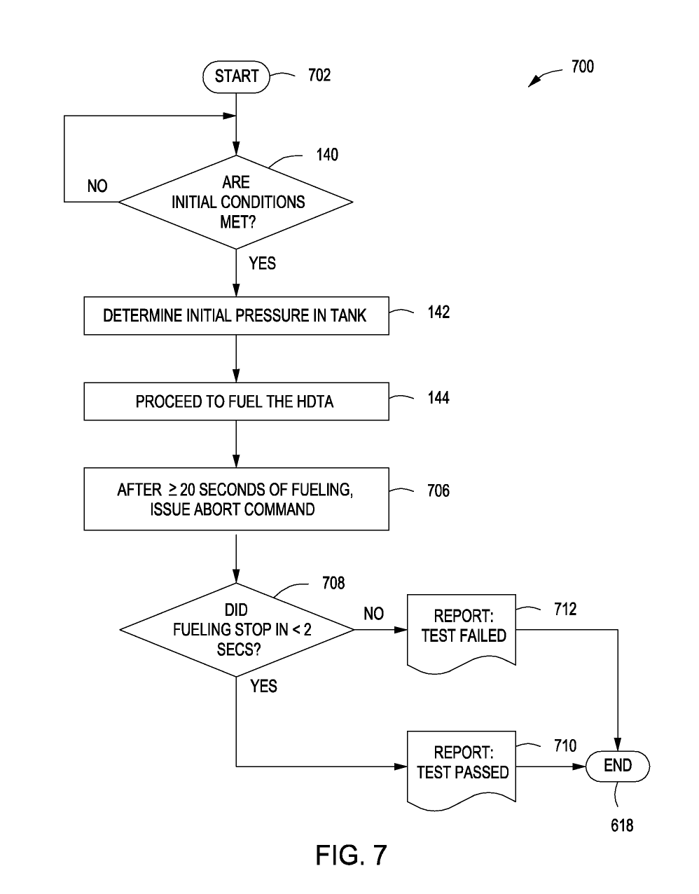

FIG. 7 is a flowchart illustrating steps that may be followed in an abort command test 700 of a hydrogen dispenser test apparatus according to an embodiment of the invention. The abort command test 700 begins at step 702, which may be initiated by a user selecting the abort command test 700, for example, as part of step 610 of the HDTA main program 600 (see FIG. 6).

In step 140 the abort command test 700 determines whether initial conditions are satisfied. Initial conditions evaluated in step 140 may include, for example, tank 14 internal or external temperature, initial pressures within the tank 14 or supply channel 34 (see FIG. 1), ambient temperature, a position of any valve within the HDTA 10 (see FIG. 1), a state of the HDTA main program 600 (see FIG. 6), a state of communication between the dispenser controller 28 and the HDTA controller 16, or combinations thereof. The aforementioned examples of initial conditions could apply to any test or method according to various embodiments of the invention. If the initial conditions are not satisfied in step 140, then the abort command test 700 repeats step 140. Alternatively, if the initial conditions are satisfied in step 140, then the abort command test 700 proceeds to step 142.

In step 142, an initial pressure of tank 14 is determined. The initial pressure within the tank 14 may be determined by direct measurement via the tank internal pressure sensor 82. Alternatively, the initial pressure within the tank 14 may be estimated by effecting a short pulse of flow across either the check valve 27 or the check valve 47, and then measuring a pressure upstream of the check valve after being pulsed. Indeed, a pressure sufficient to incipiently open either the check valve 27 or the check valve 47 would be approximately equal to the pressure downstream of the check valve plus, perhaps, an additional pressure to overcome any resilient force required to open the check valve. The aforementioned examples of determining an initial pressure in the tank could apply to any test or method according to various embodiments of the invention.

Next, the hydrogen dispenser 18 proceeds to dispense hydrogen to the HDTA 10 and concurrently a first timer is started in step 144. The first timer in step 144 may be a timer 146 internal to the HDTA controller 16 (see FIG. 1), or an external timer (not shown) in data communication with the HDTA controller 16.

In step 706, an abort command is communicated to the hydrogen dispenser 18 after at least 20 seconds has elapsed on the timer started in step 144. The abort command in step 706 may be communicated to the hydrogen dispenser 18 by the HDTA controller 16 through the dispenser data coupling 30. Alternatively, the abort command may be communicated manually to the hydrogen dispenser 18 by a user through a dispenser controller 28 user interface (not shown). Further, a second timer is started in step 706 concurrently with communicating the abort command to the hydrogen dispenser 18.

Next, in step 708, the HDTA 10 detects an end to the hydrogen dispensing started in step 144 and stops the second timer upon detecting an end to the hydrogen dispensing. The HDTA controller 16 may identify the end of hydrogen dispensing by analyzing the slope of a time series of measurements from the tank internal pressure sensor 82, analyzing the slope of a time series of measurements from the flow meter 36, receiving a signal from a flow switch (not shown) disposed in the supply channel 34, receiving a signal from the hydrogen dispenser 18, or other methods for detecting a change in flow condition known to persons having skill in the art.

If the elapsed time on the second timer between communicating the abort command to the hydrogen dispenser 18 and detecting of the end of hydrogen dispensing is less than a threshold value, then the method proceeds to step 710 where the abort command test 700 generates a report indicating that the hydrogen dispenser 18 has passed the test, and the test ends at step 618 of the HDTA main program 600. Else, if the elapsed time on the second timer between communicating the abort command to the hydrogen dispenser 18 and detecting of the end of hydrogen dispensing is not less than a threshold value, then the method proceeds to step 712 where the abort command test 700 generates a report indicating that the hydrogen dispenser 18 has failed the test, and the test ends at step 618 of the HDTA main program 600 (see FIG. 6). In one embodiment of the invention, the threshold value applied in step 708 is about two seconds. However, persons having skill in the art will appreciate that other threshold values could be applied in step 708.

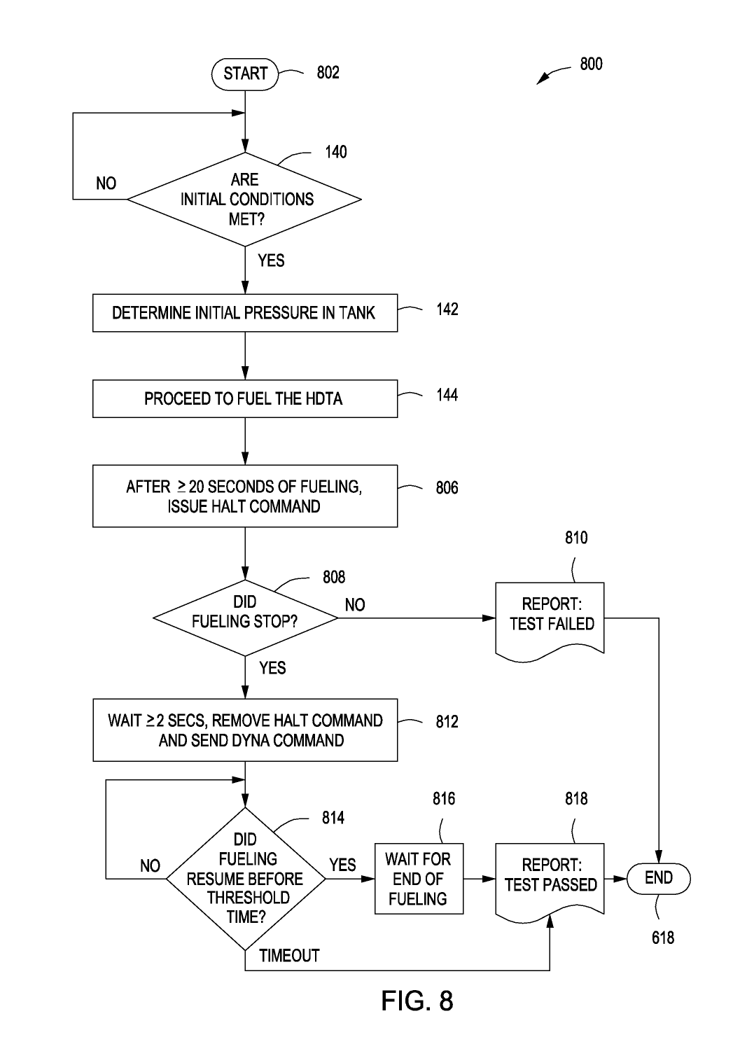

FIG. 8 is a flowchart illustrating steps that may be followed in a halt command test 800 of a hydrogen dispenser test apparatus according to an embodiment of the invention. The halt command test 800 begins at step 802, which may be initiated by a user selecting the halt command test 800, for example, as part of step 610 of the HDTA main program 600 (see FIG. 6).

In step 140 the halt command test 800 determines whether initial conditions are satisfied. When initial conditions are satisfied, the test proceeds to step 142, where an initial pressure of tank 14 is determined. Then, the hydrogen dispenser 18 proceeds to dispense hydrogen to the HDTA 10 and concurrently a first timer is started in step 144.

In step 806, a halt command is communicated to the hydrogen dispenser 18 after a first threshold value of time has elapsed on the first timer started in step 144. In one embodiment of the invention, the first threshold of time is about 20 seconds. The halt command in step 806 may be communicated to the hydrogen dispenser 18 by the HDTA controller 16 through the dispenser data coupling 30. Alternatively, the halt command may be communicated manually to the hydrogen dispenser 18 by a user through a dispenser controller 28 user interface (not shown). Further, a second timer is started in step 806 concurrently with communicating the halt command to the hydrogen dispenser 18.

Next, in step 808, the HDTA 10 detects an end to the hydrogen dispensing started in step 144 and stops the second timer upon detecting an end to the hydrogen dispensing. The HDTA controller 16 may identify the end of hydrogen dispensing by analyzing the slope of a time series of measurements from the tank internal pressure sensor 82, analyzing the slope of a time series of measurements from the flow meter 36, receiving a signal from a flow switch (not shown) disposed in the supply channel 34, receiving a signal from the hydrogen dispenser 18, or other methods for detecting a change in flow condition known to persons having skill in the art.

If an end to the hydrogen dispensing is not detected before a second threshold value of time elapses on the second timer, then the method proceeds to step 810 where the halt command test 800 generates a report indicating that the hydrogen dispenser 18 has failed the test, and the test ends at step 618 of the HDTA main program 600 (see FIG. 6). Else, if the HDTA controller 16 detects an end to hydrogen dispensing before the second threshold time has elapsed on the second timer, then the HDTA controller 16 starts a third timer concurrently with the end of hydrogen dispensing in step 808. In an embodiment of the invention, the second threshold time is about 5 seconds.

Next, in step 812, the halt command test 800 dwells until the time elapsed on the third timer is greater than or equal to a third threshold time. In one embodiment of the invention, the third threshold time is about two seconds. When the time elapsed on the third timer is greater than or equal to the third threshold value, step 812 of the halt command test 800 removes the halt command communicated in step 806, starts a fourth timer, and communicates a dynamic fueling restart command to the dispenser controller 28. The dynamic fueling restart command is intended to cause the hydrogen dispenser 18 to restart hydrogen dispensing to the HDTA 10.

Next, in step 814, the HDTA 10 detects resumption of hydrogen dispensing ended in step 808. The HDTA controller 16 may identify the resumption of hydrogen dispensing by analyzing the slope of a time series of measurements from the tank internal pressure sensor 82, analyzing the slope of a time series of measurements from the flow meter 36, receiving a signal from a flow switch (not shown) disposed in the supply channel 34, receiving a signal from the hydrogen dispenser 18, or other methods for detecting a change in flow condition known to persons having skill in the art. If hydrogen dispensing resumes before an elapsed time on the fourth timer exceeds a fourth threshold elapsed time, then the method proceeds to step 816 where the method waits for fueling to end, and then generates a report indicating that the hydrogen dispenser 18 has passed the test in step 818, and the halt command test 800 ends at step 618 of the HDTA main program 600 (see FIG. 6).

Alternatively, if hydrogen dispensing does not resume before the elapsed time on the fourth timer exceeds a fourth threshold time in step 814, then the method proceeds to step 818 where the halt command test 800 generates a report indicating that the hydrogen dispenser 18 has passed the test, and the halt command test 800 ends at step 618 of the HDTA main program 600 (see FIG. 6). The fourth threshold time is selected to ensure that fuel dispensing has terminated. In one embodiment of the invention the fourth threshold time is about 30 seconds.

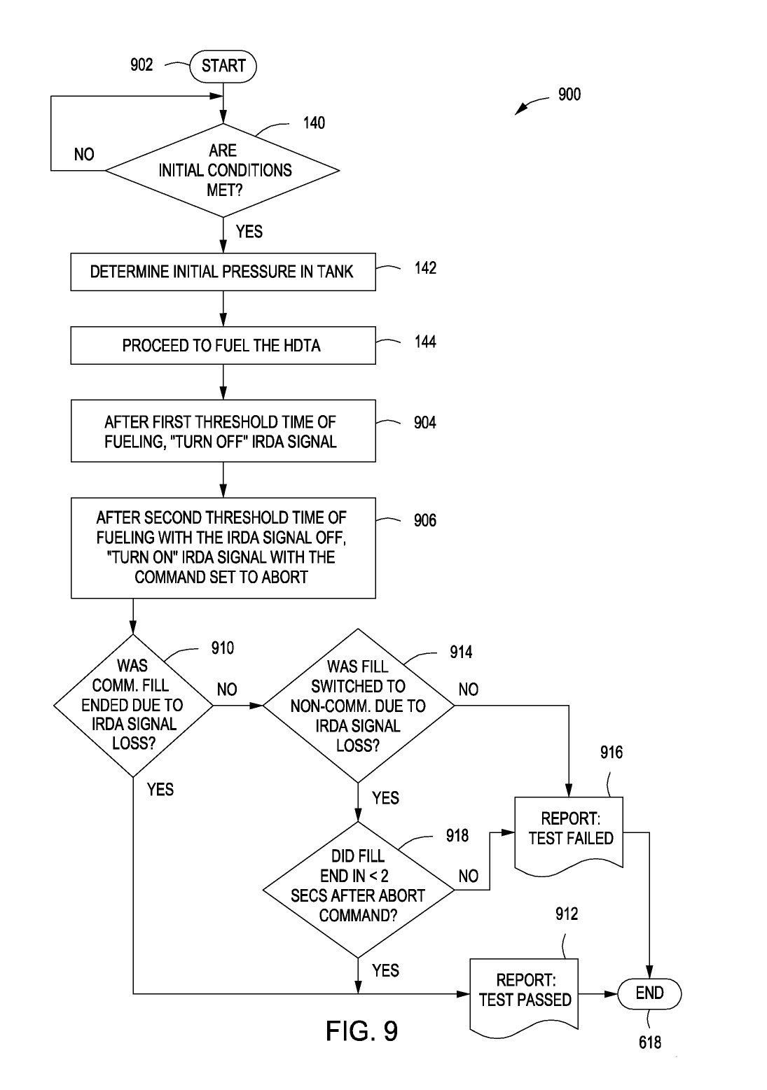

FIG. 9 is a flowchart illustrating steps that may be followed in a data loss and abort test 900 of a hydrogen dispenser test apparatus according to an embodiment of the invention. The data loss and abort test 900 begins at step 902, which may be initiated by a user selecting the data loss and abort test 900, for example, as part of step 610 of the HDTA main program 600 (see FIG. 6).

In step 140 the data loss and abort test 900 determines whether initial conditions are satisfied. When initial conditions are satisfied, the test proceeds to step 142, where an initial pressure of tank 14 is determined. Then, the hydrogen dispenser 18 proceeds to dispense hydrogen to the HDTA 10 and concurrently a first timer is started in step 144.

Next, in step 904 the HDTA controller 16 turns off communication with the dispenser controller 28 when the elapsed time on the first timer exceeds a first threshold time value. In one embodiment of the invention, the communication signal turned off in step 904 is an IRDA signal. In another embodiment of the invention, the first threshold time value is about 30 seconds. Further, in step 904, a second timer is started concurrently with the HDTA controller 16 turning off communication with the dispenser controller 28.

Then, in step 906, the HDTA controller 16 resumes communication with the dispenser controller 28 when the elapsed time on the second timer exceeds a second threshold time value. The communication signal resumed in step 906 may be the same communication signal turned off in step 904, or another communication signal with the dispenser controller 28. In one embodiment of the invention, the second threshold time value is about 30 seconds. Further, in step 906 the HDTA 10 communicates an abort command signal to the hydrogen dispenser 18 and starts a third timer.

Next, in step 910, the data loss and abort test 900 determines whether a communication filling mode of the hydrogen dispenser 18 ended after the communication signal was turned off in step 904. The HDTA controller 16 may detect whether the hydrogen dispenser 18 is operating in a communication filling mode through data communication with the dispenser controller 28 via the dispenser data coupling 30. Further, the HDTA controller 16 may detect whether the hydrogen dispenser 18 is operating in a communication filling mode by analyzing a time series of pressure measurements from a sensor within the HDTA 10, such as, for example, the tank internal pressure sensor 82.

If the communication filling mode of the hydrogen dispenser 18 ended after the communication signal was turned off in step 904, then the method proceeds to step 912 where the data loss and abort test 900 generates a report indicating that the hydrogen dispenser 18 has passed the test, and the data loss and abort test 900 ends at step 618 of the HDTA main program 600 (see FIG. 6). Else, if the filling mode of the hydrogen dispenser 18 did not end after the communication signal was turned off in step 904, then the method proceeds to step 914 where the HDTA controller determines whether the fill mode of the hydrogen dispenser was switched to a non-communication filling mode after the communication signal was turned off in step 904.

If the fill mode of the hydrogen dispenser was not switched to a non-communication filling mode after the communication signal was turned off in step 904, then the method proceeds to step 916, where the data loss and abort test 900 generates a report indicating that the hydrogen dispenser has failed the test, and the data loss and abort test 900 ends at step 618 of the HDTA main program 600 (see FIG. 6). Else, if the fill mode of the hydrogen dispenser was switched to a non-communication mode after the communication signal was turned off in step 904, the test proceeds to step 918.

In step 918, the data loss and abort test 900 determines if the hydrogen dispensing ended while an elapsed time on the third timer was less than a third threshold time after the abort command signal was communicated to the hydrogen dispenser 18 in step 906. In one embodiment of the invention, the third threshold time in test 900 is about two seconds.

If the hydrogen dispensing ended while the elapsed time on the third timer was less than the third threshold time, then the test 900 proceeds to the step 912. Else, if the hydrogen dispensing did not end while the elapsed time on the third time was less than the third threshold time, then the test 900 proceeds to the step 916.

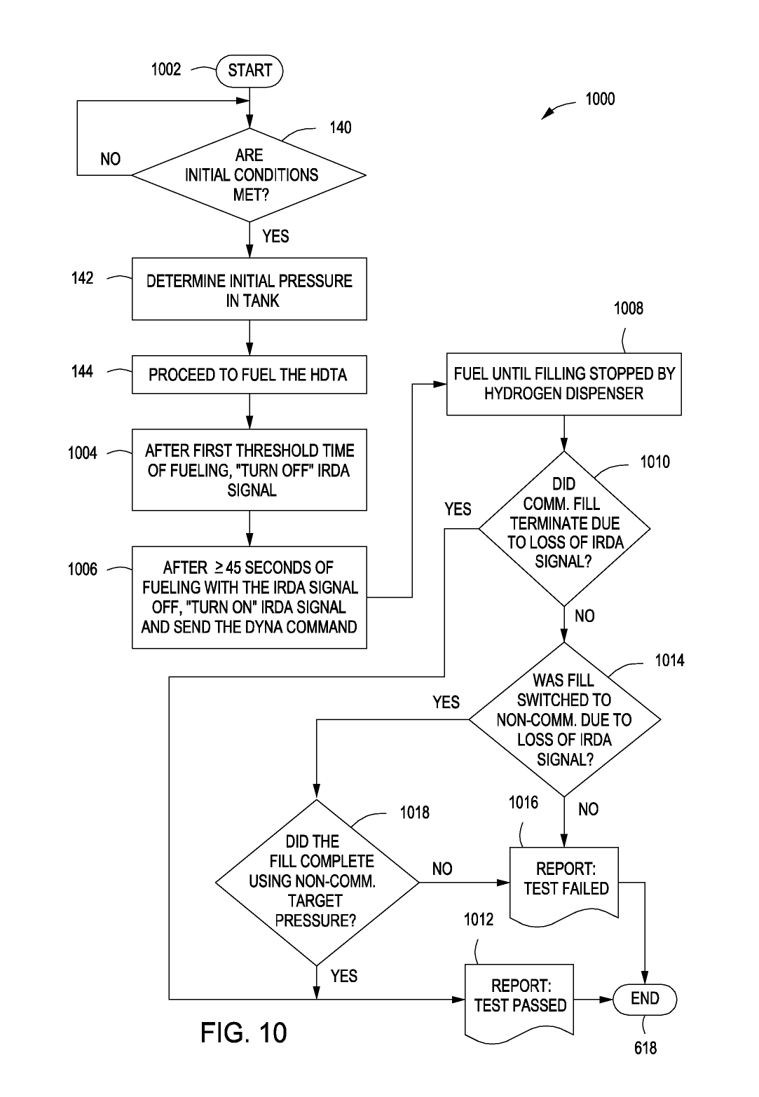

FIG. 10 is a flowchart illustrating steps that may be followed in a data loss and resumed fueling test 1000 of a hydrogen dispenser test apparatus according to an embodiment of the invention. The data loss and resumed fueling test 1000 begins at step 1002, which may be initiated by a user selecting the data loss and resumed fueling test 1000, for example, as part of step 610 of the HDTA main program 600 (see FIG. 6).

In step 140 the data loss and resumed fueling test 1000 determines whether initial conditions are satisfied. When initial conditions are satisfied, the test proceeds to step 142, where an initial pressure of tank 14 is determined. Then, the hydrogen dispenser 18 proceeds to dispense hydrogen to the HDTA 10 and concurrently a first timer is started in step 144.

Next, in step 1004 the HDTA controller 16 turns off communication with the dispenser controller 28 when the elapsed time on the first timer exceeds a first threshold time value. In one embodiment of the invention, the communication signal turned off in step 1004 is an IRDA signal. In another embodiment of the invention, the first threshold time value is about 45 seconds. Further, in step 1004, a second timer is started concurrently with the HDTA controller 16 turning off communication with the dispenser controller 28.

Then, in step 1006, the HDTA controller 16 resumes communication with the dispenser controller 28 when the elapsed time on the second timer exceeds a second threshold time value. The communication signal resumed in step 1006 may be the same communication signal turned off in step 1004, or another communication signal with the dispenser controller 28. In one embodiment of the invention, the second threshold time value is about 45 seconds. Further, in step 1006 the HDTA 10 communicates a dynamic refueling restart command signal to the hydrogen dispenser 18.

Next in step 1008 the HDTA 10 is fueled by the hydrogen dispenser 18 until the hydrogen dispenser 18 stops the fueling process. Then, in step 1010, the data loss and resumed fueling test 1000 determines whether a communication filling mode of the hydrogen dispenser 18 ended after the communication signal was turned off in step 1004. The HDTA controller 16 may detect whether the hydrogen dispenser 18 is operating in a communication filling mode through data communication with the dispenser controller 28 via the dispenser data coupling 30. Further, the HDTA controller 16 may detect whether the hydrogen dispenser 18 is operating in a communication filling mode by analyzing a time series of measurements from a sensor within the HDTA 10, such as, for example, the tank internal pressure sensor 82.

If the communication filling mode of the hydrogen dispenser 18 ended after the communication signal was turned off in step 1004, then the method proceeds to step 1012 where the data loss and resumed fueling test 1000 generates a report indicating that the hydrogen dispenser 18 has passed the test, and the data loss and resumed fueling test 1000 ends at step 618 of the HDTA main program 600 (see FIG. 6). Else, if the filling mode of the hydrogen dispenser 18 did not end after the communication signal was turned off in step 1004, then the method proceeds to step 1014 where the HDTA controller 16 determines whether the fill mode of the hydrogen dispenser was switched to a non-communication filling mode after the communication signal was turned off in step 1004.

If the fill mode of the hydrogen dispenser was not switched to a non-communication filling mode after the communication signal was turned off in step 1004, then the method proceeds to step 1016, where the data loss and resumed fueling test 1000 generates a report indicating that the hydrogen dispenser has failed the test, and the data loss and resumed fueling test 1000 ends at step 618 of the HDTA main program 600 (see FIG. 6). Else, if the fill mode of the hydrogen dispenser was switched to a non-communication mode after the communication signal was turned off in step 1004, the test proceeds to step 1018.

In step 1018, the data loss and resumed fueling test 1000 determines if the hydrogen dispenser 18 completed filling the tank 14 using a non-communicating target pressure. In one embodiment of the invention, the HDTA controller 16 determines if the hydrogen dispenser 18 completed filling the tank 14 using a non-communicating target pressure through direct communication with the hydrogen dispenser 18 through the dispenser data coupling 30. Alternatively, the HDTA controller determines if the hydrogen dispenser 18 completed filling the tank 14 using a non-communicating target pressure by analyzing a time history of measurements from a sensor in the HDTA 10, such as, for example, the tank internal pressure sensor 82.

If the hydrogen dispenser 18 completed filling the tank 14 using a non-communicating target pressure, then the test 1000 proceeds to the step 1012. Else, if the hydrogen dispenser 18 did not complete filling the tank 14 using a non-communicating target pressure, then the test 1000 proceeds to the step 1016.

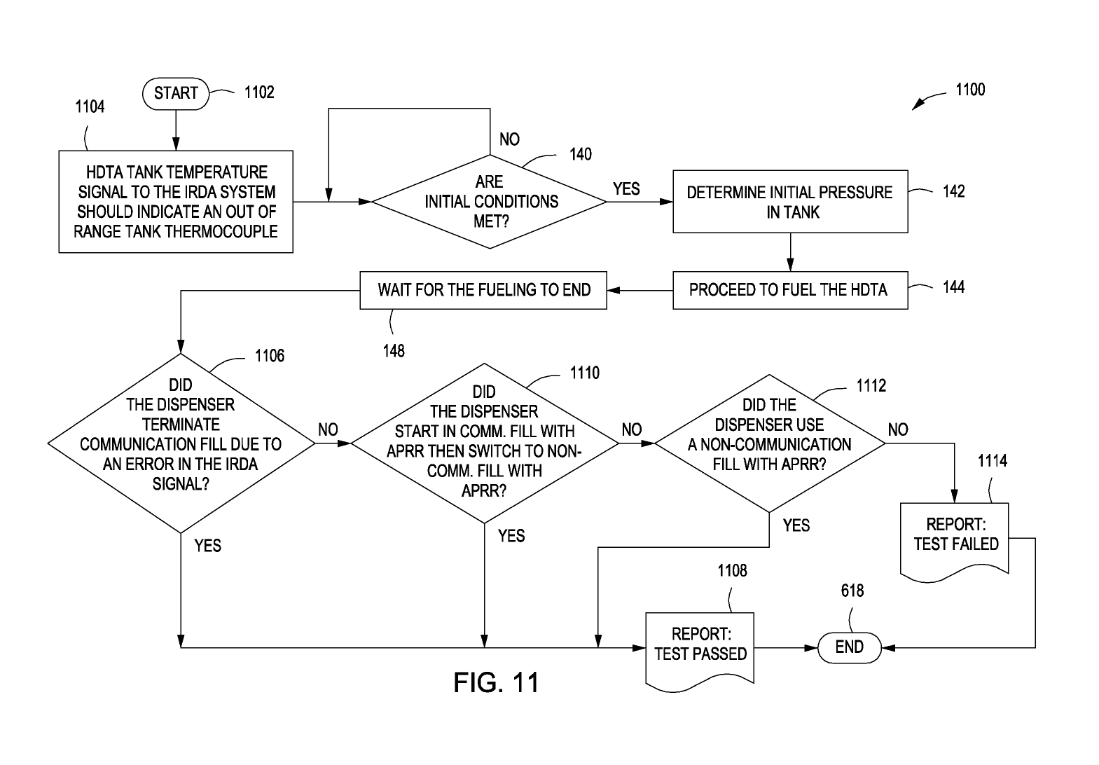

FIG. 11 is a flowchart illustrating steps that may be followed in a tank temperature communication fault test 1100 of a hydrogen dispenser test apparatus according to an embodiment of the invention. The tank temperature communication fault test 1100 begins at step 1102, which may be initiated by a user selecting the tank temperature communication fault test 1100, for example, as part of step 610 of the HDTA main program 600 (see FIG. 6).

In step 1104, a temperature signal associated with the tank 14, which is to be communicated to the hydrogen dispenser 18, is caused to indicate an out of range measurement value. In one embodiment of the invention, the temperature signal associated with the tank 14 corresponds to the tank internal temperature sensor 80 or the tank external surface temperature sensor 84. In another embodiment of the invention, the temperature signal associated with the tank 14 is a thermocouple. The temperature signal associated with the tank 14 may be caused to indicate an out of range measurement value by fabricating a temperature signal within the HDTA controller 16, by unplugging a temperature sensor in communication with the HDTA controller 16, or by coupling an electrical signal generator to a channel assigned to the temperature signal associated with the tank 14, for example.

In step 140 the tank temperature communication fault test 1100 determines whether initial conditions are satisfied. When initial conditions are satisfied, the test proceeds to step 142, where an initial pressure of tank 14 is determined. Then, the hydrogen dispenser 18 proceeds to dispense hydrogen to the HDTA 10.

Next, in step 148, when the test 1100 determines that the hydrogen dispenser 18 has ended its filling procedure, the test proceeds to step 1106. In step 1106, the test 1100 determines whether determines whether the hydrogen dispenser 18 ended its filling procedure before completing the fill because the temperature sensor was caused to read out of range in step 1104.

If the hydrogen dispenser 18 ended its filling procedure before completing the fill, then the method proceeds to step 1108 where the tank temperature communication fault test 1100 generates a report indicating that the hydrogen dispenser 18 has passed the test, and the tank temperature communication fault test 1100 ends at step 618 of the HDTA main program 600 (see FIG. 6). Else, if the hydrogen dispenser 18 did not end its filling procedure before completing the fill, then the method proceeds to step 1110, which determines whether the hydrogen dispenser 18 switched from a communicating mode using an average pressure ramp rate to a non-communicating mode using an average pressure ramp rate.

If, in step 1110, the hydrogen dispenser 18 switched from a communicating mode using an average pressure ramp rate to a non-communicating mode using an average pressure ramp rate, then the method proceeds to step 1108. Else, if the hydrogen dispenser 18 did not switch from a communicating mode using an average pressure ramp rate to a non-communicating mode using an average pressure ramp rate, then the method proceeds to step 1112.

In step 1112, the test method 1110 determines whether the hydrogen dispenser 18 used a non-communicating mode using an average pressure ramp rate. If the hydrogen dispenser 18 used a non-communicating mode with an average pressure ramp rate, then the method proceeds to step 1108. Else, if the hydrogen dispenser 18 did not use a non-communicating mode with an average pressure ramp rate, then the method proceeds to step 1108 where the tank temperature communication fault test 1100 generates a report indicating that the hydrogen dispenser 18 has failed the test, and the tank temperature communication fault test 1100 ends at step 618 of the HDTA main program 600 (see FIG. 6).

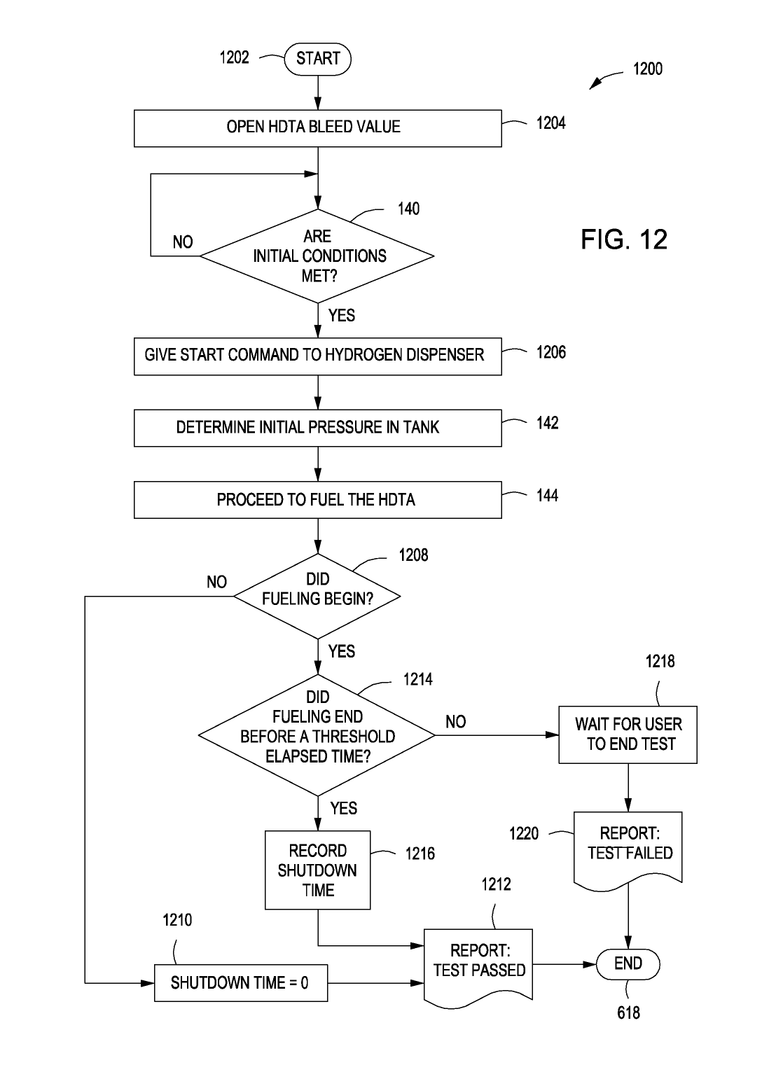

FIG. 12 is a flowchart illustrating steps that may be followed in a leak detection at start of fueling test 1200 of a hydrogen dispenser test apparatus according to an embodiment of the invention. The leak detection at start of fueling test 1200 begins at step 1202, which may be initiated by a user selecting the leak detection at start of fueling test 1200, for example, as part of step 610 of the HDTA main program 600 (see FIG. 6).

In step 1204, an HDTA bleed valve, which is in fluid communication with the supply channel 34, is opened. The bleed valve could be an isolation valve such as the first bleed isolation valve 58 (FIG. 1) or the second bleed isolation valve 62, for example. Further, the HDTA bleed valve could be opened manually by a user of the HDTA 10 or could be opened automatically by a signal from the HDTA controller 16 to an actuator coupled to the HDTA bleed valve.

In step 140 the a leak detection at start of fueling test 1200 determines whether initial conditions are satisfied. When initial conditions are satisfied, a start command is given to the hydrogen dispenser 18 in step 1206. The start command could be given to the hydrogen dispenser 18 manually by the user through a user interface of the hydrogen dispenser 18. Alternatively, the start command could be transmitted from the HDTA 10 directly to the dispenser controller 28 through the dispenser data coupling 30. Next, the test proceeds to step 142, where an initial pressure of tank 14 is determined by means previously discussed. Then, the hydrogen dispenser 18 proceeds to dispense hydrogen to the HDTA 10 and a first timer is started in step 144.

Next, in step 1208, the test 1200 determines if fueling began. In step 1208, the HDTA controller may determine whether fueling began by analyzing a time history of flow or pressure data collected from the HDTA 10, by direct communication between the hydrogen dispenser 18 and the HDTA 10, or combinations thereof. Step 1208 is helpful because the hydrogen dispenser 18 may have detected the leak path through the bleed valve opened in step 1204, and then shutdown operation of the hydrogen dispenser 18 before fueling could begin in step 144.

If fueling never began, then the test 1200 may proceed to step 1210 where the HDTA controller 16 may assign a shutdown time of zero seconds. Then, in step 1212, the leak detection at start of fueling test 1200 generates a report indicating that the hydrogen dispenser 18 has passed the test, and the leak detection at start of fueling test 1200 ends at step 618 of the HDTA main program 600 (see FIG. 6).

Else, if step 1208 determines that fueling began, then the test 1200 proceeds to step 1214, where it is determined whether fueling ended before an elapsed time on the first timer exceeded a first threshold time. In one advantageous embodiment, the first threshold time is between about 1 second and about 4 seconds. If the fueling ended before an elapsed time on the first timer exceeded the first threshold time, then the time to end fueling, according to the first timer, is recorded, for example, in a memory of the HDTA controller 16, and the test proceeds to step 1212.

If the fueling did not end before the elapsed time on the first timer exceed the first threshold time, then the method waits for the test to end in step 1218. In step 1218, the user may manually end the test through a user interface with the hydrogen dispenser 18, or the test may end automatically under the control of the HDTA controller 16. Then, in step 1220, the leak detection at start of fueling test 1200 generates a report indicating that the hydrogen dispenser 18 has failed the test, and the leak detection at start of fueling test 1200 ends at step 618 of the HDTA main program 600 (see FIG. 6).

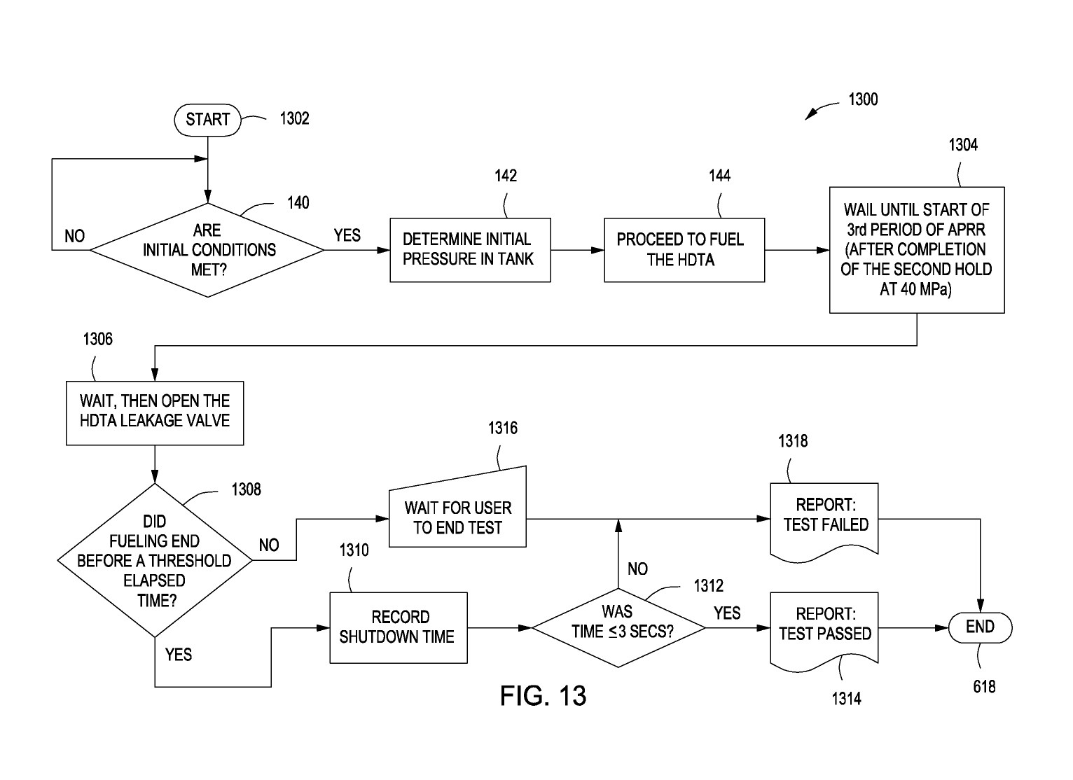

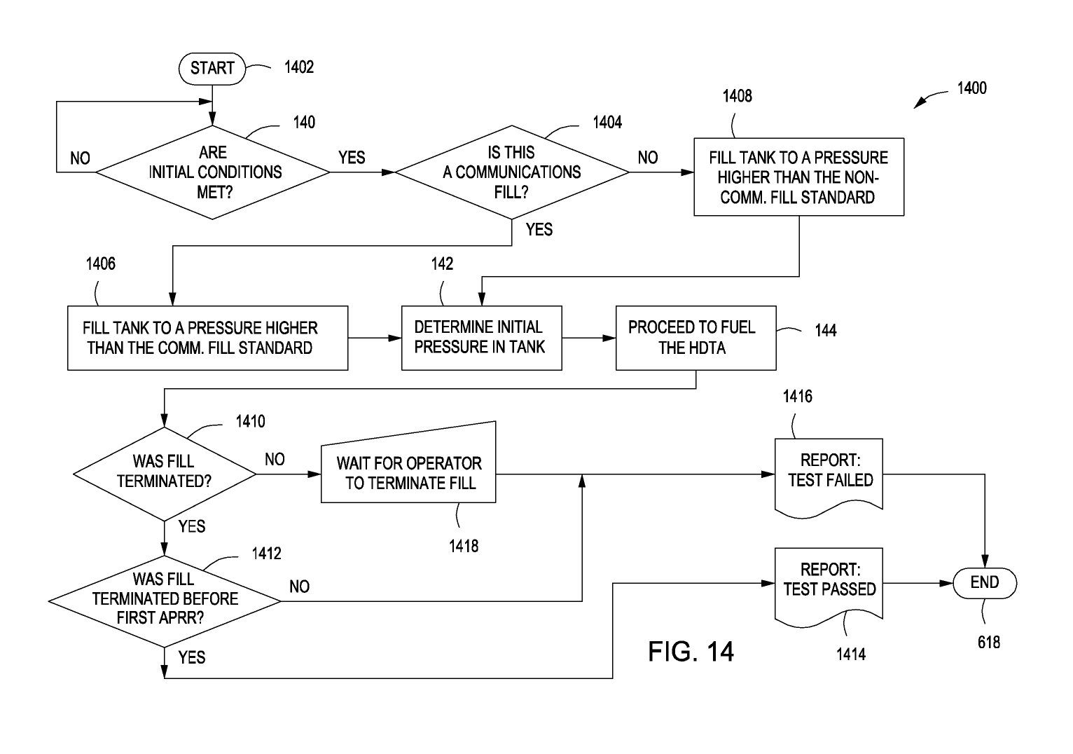

FIG. 13 is a flowchart illustrating steps that may be followed in a leak during fueling test 1300 of a hydrogen dispenser test apparatus according to an embodiment of the invention. The leak during fueling test 1300 begins at step 1302, which may be initiated by a user selecting the leak during fueling test 1300, for example, as part of step 610 of the HDTA main program 600 (see FIG. 6).

In step 140 the tank temperature communication fault test 1300 determines whether initial conditions are satisfied. When initial conditions are satisfied, the test proceeds to step 142, where an initial pressure of tank 14 is determined by means discussed previously. Then, the hydrogen dispenser 18 proceeds to dispense hydrogen to the HDTA 10 in step 144.

Next, in step 1304, the HDTA controller 16 observes process variables to detect a trigger for opening an HDTA bleed valve to simulate a leak out of the supply channel 34. The trigger for opening the HDTA bleed valve could include, for example, a threshold amount of hydrogen dispensed, a pressure within the HDTA 10 exceeding a threshold pressure, an inflection in a time history of a pressure within the HDTA 10, detecting a defined mode of hydrogen dispensing, such as, for example, an average pressure ramp rate, an elapsed time of hydrogen dispensing exceeding a threshold time, or combinations thereof. In one advantageous embodiment of the invention, the step 1304 acts to identify a third period of average pressure ramp rate, after a completion of a second pressure hold at about 5800 psig (40 MPa), as the trigger for opening the HDTA bleed valve. Once the trigger is identified in step 1304, a first timer is started and the test proceeds to step 1306.

In step 1306, the HDTA controller 16 opens an HDTA bleed valve, which is in fluid communication with the supply channel 34, when an elapsed time on the first timer exceeds a first threshold time value. In one embodiment, the first threshold time value is about 10 seconds. The bleed valve could be an isolation valve such as the first bleed isolation valve 58 (FIG. 1) or the second bleed isolation valve 62 (FIG. 1), for example. Further, the HDTA bleed valve could be opened manually by a user of the HDTA 10 or could be opened automatically by a signal from the HDTA controller 16 to an actuator coupled to the HDTA bleed valve.

Next, in step 1308, the test 1300 determines if the hydrogen dispenser 18 shuts down before an elapsed time on the first timer exceeds a first threshold time. If the hydrogen dispenser 18 shuts down before an elapsed time on the first timer exceeds a first threshold time, then the elapsed time to shutdown is recorded in step 1310. Then, the elapsed time to shutdown is compared to a second threshold time in step 1312. If the elapsed time to shutdown is not greater than a second threshold time, then in step 1314, the leak during fueling test 1300 generates a report indicating that the hydrogen dispenser 18 has passed the test, and the leak during fueling test 1300 ends at step 618 of the HDTA main program 600 (see FIG. 6). In one embodiment of the invention, the second threshold time is about three seconds, and the first threshold time is greater than the second threshold time.

Else, if the hydrogen dispenser did not shut down before an elapsed time on the first timer exceeds the first threshold value, then the method waits for the test to end in step 1316. The test may end in step 1316 by the user manually shutting down the hydrogen dispenser 18 through a user interface on the hydrogen dispenser 18, or the HDTA controller 16 may end the test by direct communication with the hydrogen dispenser 18. When the test has ended, the method proceeds to step 1318, where the leak during fueling test 1300 generates a report indicating that the hydrogen dispenser 18 has failed the test, and the leak during fueling test 1300 ends at step 618 of the HDTA main program 600 (see FIG. 6).

FIG. 14 is a flowchart illustrating steps that may be followed in an initial tank overpressure test 1400 of a hydrogen dispenser test apparatus according to an embodiment of the invention. The initial tank overpressure test 1400 begins at step 1402, which may be initiated by a user selecting the initial tank overpressure test 1400, for example, as part of step 610 of the HDTA main program 600 (see FIG. 6).

In step 140 the initial tank overpressure test 1400 determines whether initial conditions are satisfied. When initial conditions are satisfied, the test proceeds to step 1404, where the HDTA controller receives an indication whether the test will proceed with communication between the HDTA 10 and the hydrogen dispenser 18, for example through the dispenser data coupling 30, or without communication between the HDTA 10 and the hydrogen dispenser 18. The user may choose between the communication and non-communication test options from a user interface (not shown) with the HDTA controller 16, for example.

If a communication test option is chosen, then the method 1400 proceeds to step 1406, where the tank 14 is filled with a fluid to a pressure that exceeds a maximum allowable initial tank pressure for a filling procedure including communication between the HDTA 10 and the hydrogen dispenser 18. In one embodiment of the invention, the maximum allowable initial tank pressure for a filling procedure including communication is a pressure corresponding to a completely full tank 14. Any fluid may be used to increase the pressure within the tank 14 during step 1406, such as, for example, hydrogen, nitrogen, argon, water, or other fluids known to persons having skill in the art having low potential for chemical reactions with hydrogen.

If a non-communication test option is chosen, then the method 1400 proceeds to step 1408, where the tank 14 is filled with a fluid to a pressure that exceeds a maximum allowable initial tank pressure for a filling procedure including communication between the HDTA 10 and the hydrogen dispenser 18. In another embodiment of the invention, the maximum allowable initial tank pressure for a filling procedure not including communication is a final target filling pressure from SAE J2601 tables 8-1 to 8-8. In yet another embodiment, the maximum allowable initial tank pressure, independent of communication status, is between about 8,700 psig (60 MPa) to about 10,900 psig (75 MPa), to accommodate a particular design for tank 14. In still yet another embodiment, the maximum allowable initial tank pressure, independent of communication status, is between about 4,350 psig (30 MPa) to about 5,800 psig (40 MPa) to accommodate another particular design for tank 14.

In step 142, an initial pressure of tank 14 is determined by means discussed previously. Then, the hydrogen dispenser 18 proceeds to dispense hydrogen to the HDTA 10 in step 144.

Next, in step 1410, the method 1400 determines whether the hydrogen dispenser 18 terminated the filling procedure. If the hydrogen dispenser 18 terminated the filling procedure, then the method proceeds to step 1412, where the method 1400 determines if the filling procedure was terminated before a defined filling stage. The defined filling stage in step 1412 could be an elapsed time since the start of filling, an amount of hydrogen delivered to the HDTA, a threshold pressure increase in the tank 14 due to the filling, an inflection point in a time history of the tank 14 pressure during filling, a particular average pressure ramp rate, or combinations thereof. In one advantageous embodiment of the invention, the defined filling stage evaluated in step 1412 is the first average pressure ramp rate as defined in SAE J2601, for example.

If the filling procedure was terminated before the defined filling stage, then the method 1400 proceeds to step 1414, where the initial tank overpressure test 1400 generates a report indicating that the hydrogen dispenser 18 has passed the test, and the initial tank overpressure test 1400 ends at step 618 of the HDTA main program 600 (see FIG. 6). Else, if the filling procedure was not terminated before the defined filling stage in step 1412, then the method 1400 proceeds to step 1416, where the initial tank overpressure test 1400 generates a report indicating that the hydrogen dispenser 18 has failed the test, and the initial tank overpressure test 1400 ends at step 618 of the HDTA main program 600 (see FIG. 6).

If it is determined in step 1410 that the fill was not terminated, then the method 1400 proceeds to step 1418 where the filling procedure is terminated. The filling procedure may be terminated in step 1418 by a user manually stopping the fill, for example, through an interface with the hydrogen dispenser 18, or the HDTA controller 16 may end the filling procedure through direct communication with the hydrogen dispenser 18. When the filling procedure has ended in step 1418, then the method 1400 proceed to step 1416.

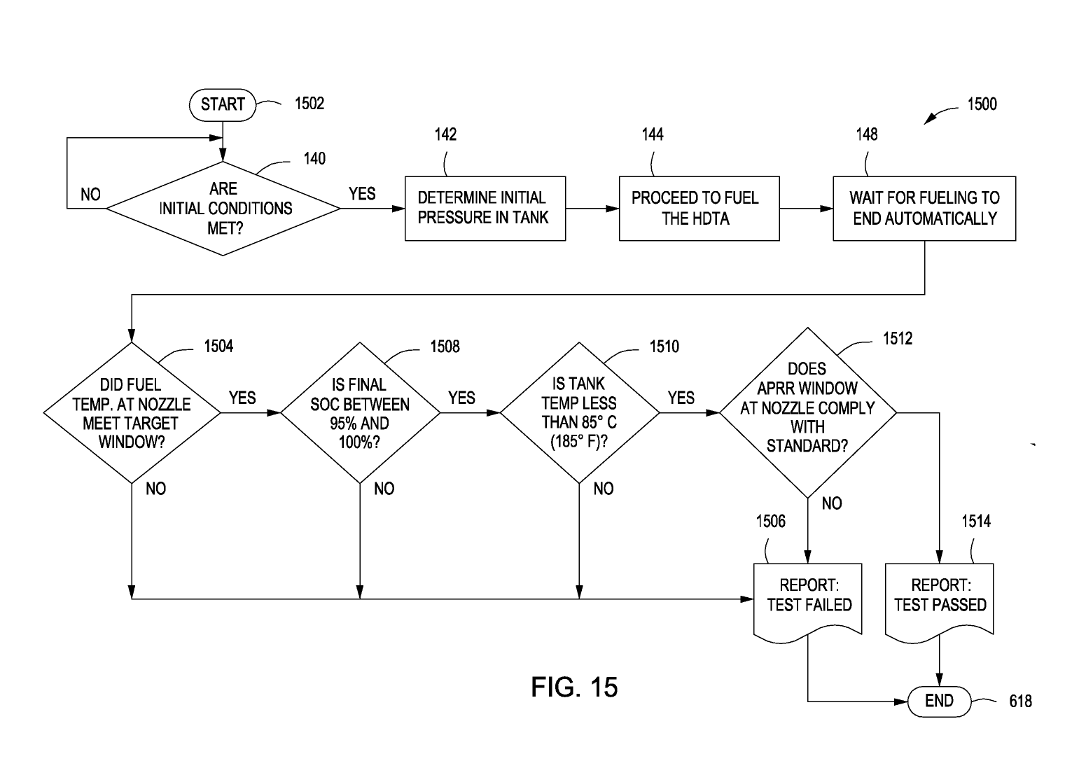

FIG. 15 is a flowchart illustrating steps that may be followed in a first communication fill test 1500 of a hydrogen dispenser test apparatus including a first tank design according to an embodiment of the invention. The hydrogen dispenser 18 is in data communication with the HDTA 10 during the first communication fill test 1500.

In one embodiment of the invention, the first tank design is a tank that is designed to contain less than or equal to about 15.4 lbm (7 kg) of hydrogen at 100% state of charge. In another embodiment of the invention, the first tank design is a 10,152 psig (70 MPa) type IV hydrogen gas vehicle fuel tank design with a polymer liner, a nominal water volume of about 9,398 cubic inches (154 liters), and an outer diameter of about 22 inches (507 mm). The first communication fill test 1500 begins at step 1502, which may be initiated by a user selecting the first communication fill test 1500, for example, as part of step 610 of the HDTA main program 600 (see FIG. 6).

In step 140 the first communication fill test 1500 determines whether initial conditions are satisfied. When initial conditions are satisfied, the test proceeds to step 142, where an initial pressure of tank 14 is determined according to methods previously discussed. Next, the hydrogen dispenser 18 proceeds to dispense hydrogen to the HDTA 10. Then, in step 148, the method 1500 waits for the fueling of the HDTA 10 by the hydrogen dispenser 18 to end automatically.

In step 1504, the method compares at least one temperature measurement from near the inlet to the HDTA to a target window of temperatures. The target window of temperatures may be defined by an industrial standard or guideline, such as, for example, SAE TIR J2601. In one advantageous embodiment, the temperature near the inlet to the HDTA is measured from the HDTA inlet temperature sensor 38. Further, step 1504 may compare a plurality of temperature measurements from a time series of temperature measurements to the target window of temperatures. If the fuel temperature measurement near the inlet to the HDTA does not lie within the target window of temperatures, then the method 1500 proceeds to step 1506, where the first communication fill test 1500 generates a report indicating that the hydrogen dispenser 18 has failed the test, and the first communication fill test 1500 ends at step 618 of the HDTA main program 600 (see FIG. 6).

Else, if the fuel temperature measurement near the inlet to the HDTA does lie within the target window of temperatures, then the method 1500 proceed to step 1508, where the HDTA controller determines if the final state of charge of the tank is between about 95% to about 100%. If the final state of charge of the tank is not between about 95% and about 100%, then the method 1500 proceeds to step 1506.

If the final state of charge of the tank is between about 95% and about 100%, then the method 1500 proceeds to step 1510, where the method 1500 determines whether the tank temperature is less than a threshold temperature. In one embodiment of the invention, the threshold temperature in Step 1510 is about 185 degrees Fahrenheit (85 degrees Celsius). If the tank temperature is not less than the threshold temperature, then the method 1500 proceeds to stop 1506.

If the tank temperature is less than the threshold temperature, then the method proceeds to step 1512, where the method 1500 determines if a measured rate of fill complied with a predefined standard. The predefined standard may include a time history of pressures within the tank 14, or a time history of flow rates into the tank 14, or combinations thereof, for example.

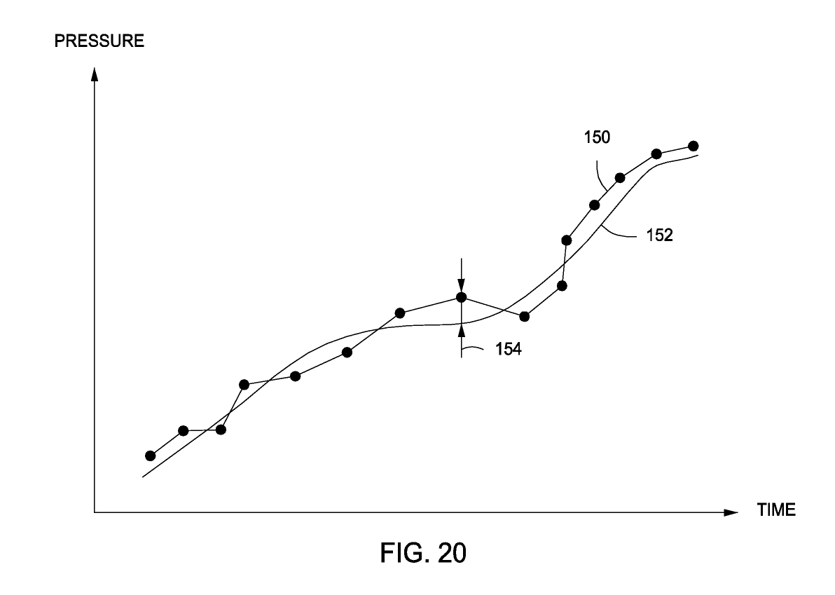

In one embodiment of the invention, as shown in FIG. 20, a time history of tank internal pressure measurements 150 is compared to a time schedule of target tank internal pressures 152. The method 1500 may calculate differences 154 between the measured time history of values and compare the differences to threshold tolerances to determine if the measured rate of fill complied with the predefined standard. In another embodiment of the invention, the method 1500 may calculate a cumulative measure of the residual between each measured value and its corresponding value according to the predefined standard and compare the cumulative measure of the residuals to a cumulative tolerance. The cumulative measure of residuals could include, for example, a sum of the residuals, a sum of the absolute values of the residuals, the square root of the sum of the squares of the residuals, or other cumulative residual measures known to persons having skill in the art.

If the method 1500 determines that the measured rate of fill did not comply with the predefined standard, then the method 1500 proceeds to step 1506. Else, if the method 1500 determines that the measured rate of fill did comply with the predefined standard, then the method 1500 proceeds to step 1514, where the first communication fill test 1500 generates a report indicating that the hydrogen dispenser 18 has passed the test, and the first communication fill test 1500 ends at step 618 of the HDTA main program 600 (see FIG. 6).

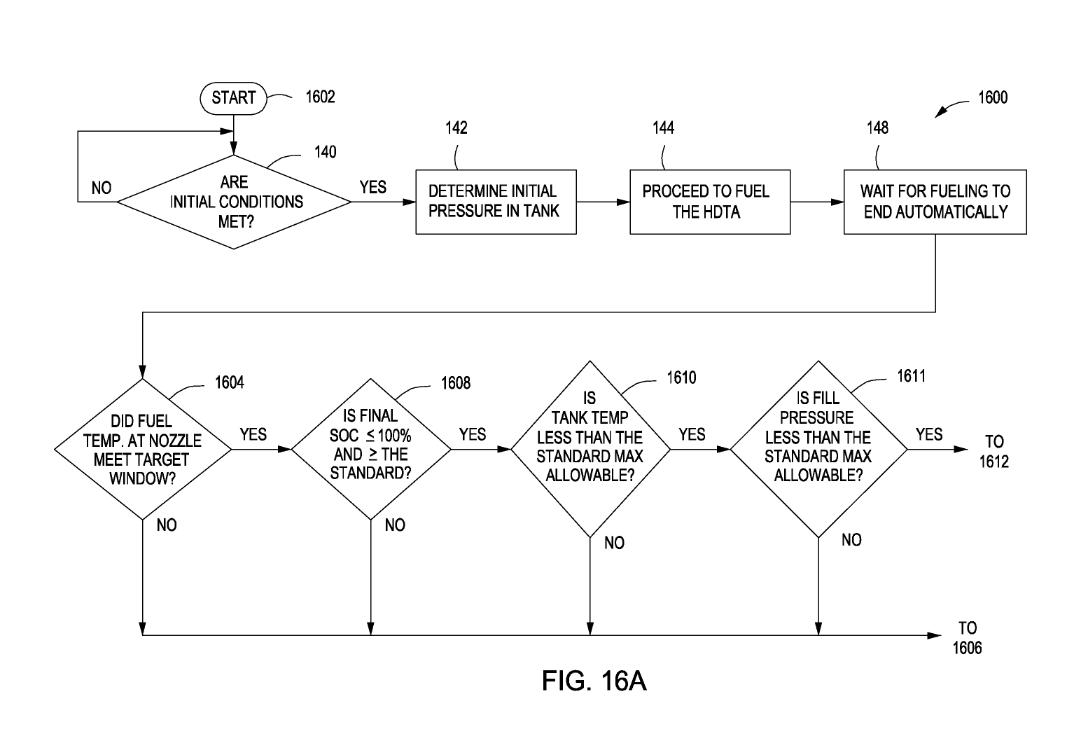

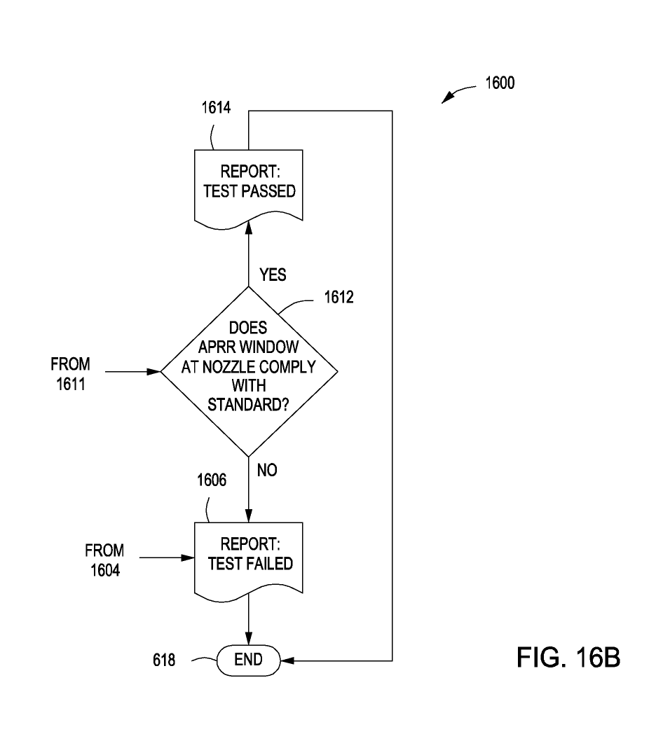

FIG. 16 is a flowchart illustrating steps that may be followed in a first non-communication fill test 1600 of a hydrogen dispenser test apparatus including a first tank design according to an embodiment of the invention. The hydrogen dispenser 18 is not in data communication with the HDTA 10 during the first non-communication fill test 1600.

In one embodiment of the invention, the first tank design is a tank that is designed to contain less than or equal to about 15.4 lbm (7 kg) of hydrogen at 100% state of charge. In another embodiment of the invention, the first tank design is a 10,152 psig (70 MPa) type IV hydrogen gas vehicle fuel tank design with a polymer liner, a nominal water volume of about 9,398 cubic inches (154 liters), and an outer diameter of about 22 inches (507 mm). The first non-communication fill test 1600 begins at step 1602, which may be initiated by a user selecting the first non-communication fill test 1600, for example, as part of step 610 of the HDTA main program 600 (see FIG. 6).

In step 140 the first non-communication fill test 1600 determines whether initial conditions are satisfied. When initial conditions are satisfied, the test proceeds to step 142, where an initial pressure of tank 14 is determined according to methods previously discussed. Next, the hydrogen dispenser 18 proceeds to dispense hydrogen to the HDTA 10. Then, in step 148, the method 1600 waits for the fueling of the HDTA 10 by the hydrogen dispenser 18 to end automatically.

In step 1604, the method compares at least one temperature measurement from near the inlet to the HDTA to a target window of temperatures. The target window of temperatures may be defined by an industrial standard or guideline, such as, for example, SAE TIR J2601. In one advantageous embodiment, the temperature near the inlet to the HDTA is measured from the HDTA inlet temperature sensor 38. Further, step 1604 may compare a plurality of temperature measurements from a time series of temperature measurements to the target window of temperatures. If the fuel temperature measurement near the inlet to the HDTA does not lie within the target window of temperatures, then the method 1600 proceeds to step 1606, where the first non-communication fill test 1600 generates a report indicating that the hydrogen dispenser 18 has failed the test, and the first non-communication fill test 1600 ends at step 618 of the HDTA main program 600 (see FIG. 6).

Else, if the fuel temperature measurement near the inlet to the HDTA does lie within the target window of temperatures, then the method 1600 proceeds to step 1608, where the HDTA controller determines if the final state of charge of the tank is less than or equal to 100% and greater than or equal to a standard threshold fill value. In one embodiment, the standard threshold fill value is determined from the SAE TIR J2601 guideline, for example. If the final state of charge of the tank is the final state of charge of the tank is greater than 100% or less than the standard threshold fill value, then the method 1600 proceeds to step 1606.

If the final state of charge of the tank is less than or equal to 100% and greater than or equal to a standard threshold fill value, then the method 1600 proceeds to step 1610, where the method 1600 determines whether the tank temperature is less than a threshold temperature. In one embodiment of the invention, the threshold temperature in Step 1610 is about 185 degrees Fahrenheit (85 degrees Celsius). If the tank temperature is not less than the threshold temperature, then the method 1600 proceeds to stop 1606.

If the tank temperature is less than the threshold temperature, then the method proceeds to step 1611 where the method 1600 determines if the fill pressure is less than a standard maximum allowable pressure. If the fill pressure is not less than the standard maximum allowable pressure, then the method 1600 proceeds to step 1606.

Else, if the fill pressure is less than the standard maximum allowable pressure, then the method 1600 proceeds to step 1612, where the method 1600 determines if a measured rate of fill complied with a predefined standard. The method 1600 may determine if the measured rate of fill complied with the predefined standard similarly to that regarding step 1512 (FIG. 15) as previously discussed.

If the method 1600 determines that the measured rate of fill did not comply with the predefined standard, then the method 1600 proceeds to step 1606. Else, if the method 1600 determines that the measured rate of fill did comply with the predefined standard, then the method 1600 proceeds to step 1614, where the first non-communication fill test 1600 generates a report indicating that the hydrogen dispenser 18 has passed the test, and the first non-communication fill test 1600 ends at step 618 of the HDTA main program 600 (see FIG. 6).

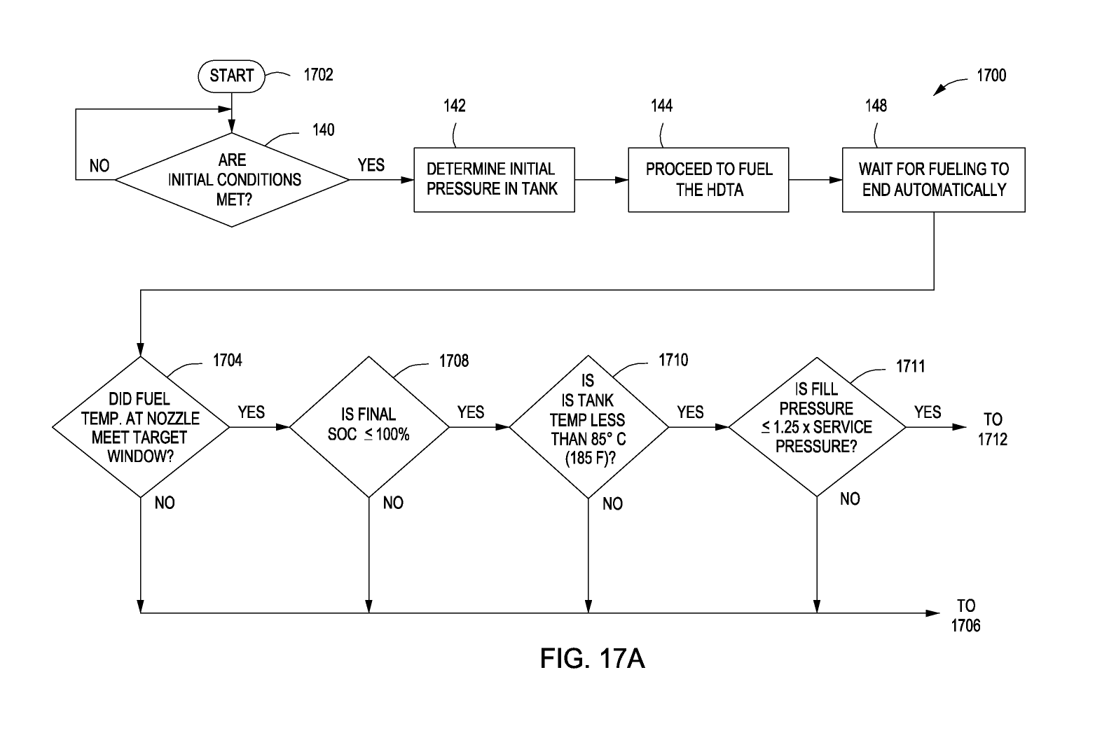

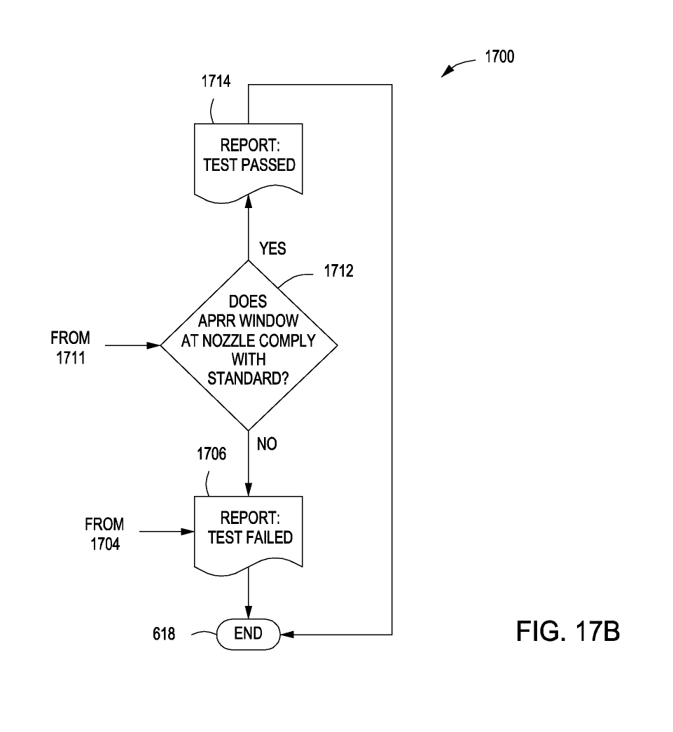

FIG. 17 is a flowchart illustrating steps that may be followed in a second communication fill test 1700 of a hydrogen dispenser test apparatus including a second tank design according to an embodiment of the invention. The hydrogen dispenser 18 is in data communication with the HDTA 10 during the second communication fill test 1700.

In one embodiment of the invention, the second tank design is a tank that is designed to contain from about 15.4 lbm (7 kg) to about 22 lbm (10 kg) of hydrogen at 100% state of charge. In another embodiment of the invention, the second tank design is a 10,152 psig (70 MPa) type IV hydrogen gas vehicle fuel tank design with a polymer liner, a nominal water volume of about 15,195 cubic inches (249 liters), and an outer diameter of about 22 inches (507 mm). The second communication fill test 1700 begins at step 1702, which may be initiated by a user selecting the second communication fill test 1700, for example, as part of step 610 of the HDTA main program 600 (see FIG. 6).

In step 140 the second communication fill test 1700 determines whether initial conditions are satisfied. When initial conditions are satisfied, the test proceeds to step 142, where an initial pressure of tank 14 is determined according to methods previously discussed. Next, the hydrogen dispenser 18 proceeds to dispense hydrogen to the HDTA 10. Then, in step 148, the method 1700 waits for the fueling of the HDTA 10 by the hydrogen dispenser 18 to end automatically.

In step 1704, the method compares at least one temperature measurement from near the inlet to the HDTA to a target window of temperatures. The target window of temperatures may be defined by an industrial standard or guideline, such as, for example, SAE TIR J2601. In one advantageous embodiment, the temperature near the inlet to the HDTA is measured from the HDTA inlet temperature sensor 38. Further, step 1704 may compare a plurality of temperature measurements from a time series of temperature measurements to the target window of temperatures. If the fuel temperature measurement near the inlet to the HDTA does not lie within the target window of temperatures, then the method 1700 proceeds to step 1706, where the second communication fill test 1700 generates a report indicating that the hydrogen dispenser 18 has failed the test, and the second communication fill test 1700 ends at step 618 of the HDTA main program 600 (see FIG. 6).

Else, if the fuel temperature measurement near the inlet to the HDTA does lie within the target window of temperatures, then the method 1700 proceed to step 1708, where the HDTA controller determines if the final state of charge of the tank is less than or equal to 100%. If the final state of charge of the tank is greater than 100%, then the method 1700 proceeds to step 1706.

If the final state of charge of the tank is less than or equal to 100%, then the method 1700 proceeds to step 1710, where the method 1700 determines whether the tank temperature is less than a threshold temperature. In one embodiment of the invention, the threshold temperature in Step 1710 is about 185 degrees Fahrenheit (85 degrees Celsius). If the tank temperature is not less than the threshold temperature, then the method 1700 proceeds to stop 1706.

If the tank temperature is less than the threshold temperature, then the method proceeds to step 1711, where the method 1700 determines if the final fill pressure of the tank 14 is less than or equal to 1.25 times a nominal working pressure (NWP) or service pressure of the tank 14. The NWP for the tank 14 is determined as a function of its design. If the final fill pressure of the tank 14 is greater than 1.25 times a NWP or service pressure of the tank 14, then the method 1700 proceeds to step 1706.

Else, if the final fill pressure of the tank 14 is greater than 1.25 times a NWP or service pressure of the tank 14, then the method proceeds to step 1712, where the method 1700 determines if a measured rate of fill complied with a predefined standard. The method 1700 may determine if the measured rate of fill complied with the predefined standard similarly to that previously discussed regarding step 1512 (FIG. 15).

If the method 1700 determines that the measured rate of fill did not comply with the predefined standard, then the method 1700 proceeds to step 1706. Else, if the method 1700 determines that the measured rate of fill did comply with the predefined standard, then the method 1700 proceeds to step 1714, where the second communication fill test 1700 generates a report indicating that the hydrogen dispenser 18 has passed the test, and the second communication fill test 1700 ends at step 618 of the HDTA main program 600 (see FIG. 6).

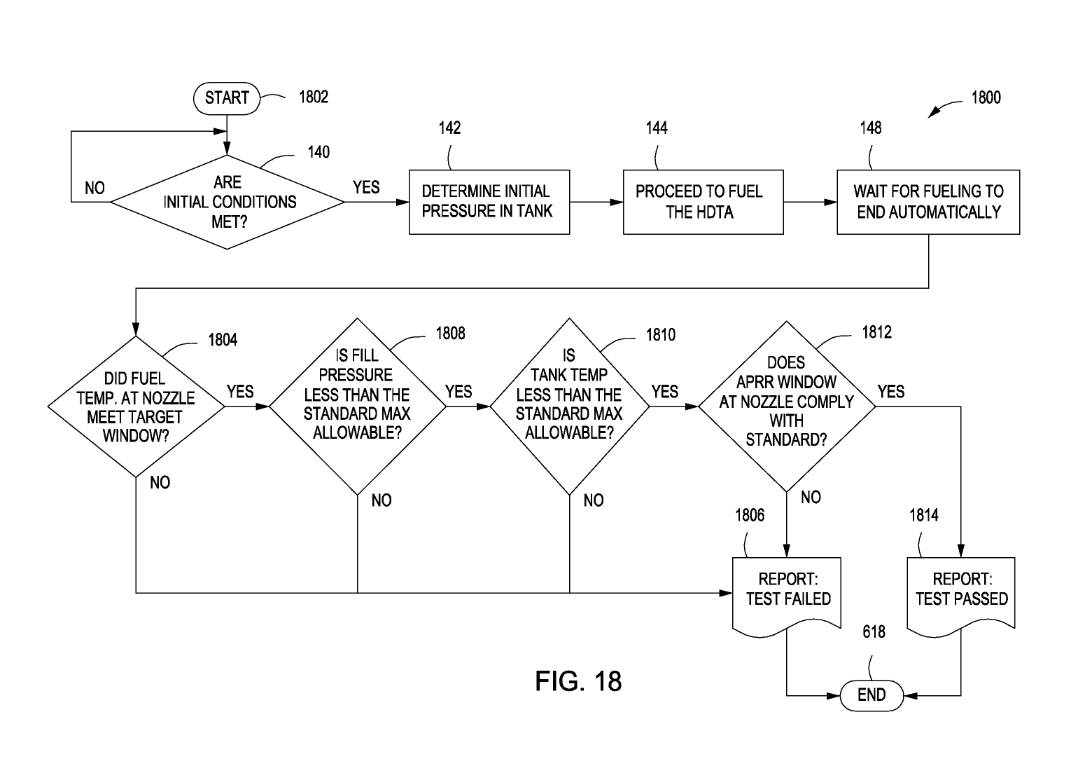

FIG. 18 is a flowchart illustrating steps that may be followed in a second non-communication fill test 1800 of a hydrogen dispenser test apparatus including a second tank design according to an alternate embodiment of the invention. The hydrogen dispenser 18 is not in data communication with the HDTA 10 during the second non-communication fill test 1800.

In one embodiment of the invention, the second tank design is a tank that is designed to contain from about 15.4 lbm (7 kg) to about 22 lbm (10 kg) of hydrogen at 100% state of charge. In another embodiment of the invention, the second tank design is a 10,152 psig (70 MPa) type IV hydrogen gas vehicle fuel tank design with a polymer liner, a nominal water volume of about 15,195 cubic inches (249 liters), and an outer diameter of about 22 inches (507 mm). The second non-communication fill test 1800 begins at step 1802, which may be initiated by a user selecting the second non-communication fill test 1800, for example, as part of step 610 of the HDTA main program 600 (see FIG. 6).

In step 140 the second non-communication fill test 1800 determines whether initial conditions are satisfied. When initial conditions are satisfied, the test proceeds to step 142, where an initial pressure of tank 14 is determined according to methods previously discussed. Next, the hydrogen dispenser 18 proceeds to dispense hydrogen to the HDTA 10. Then, in step 148, the method 1800 waits for the fueling of the HDTA 10 by the hydrogen dispenser 18 to end automatically.

In step 1804, the method compares at least one temperature measurement from near the inlet to the HDTA to a target window of temperatures. The target window of temperatures may be defined by an industrial standard or guideline, such as, for example, SAE TIR J2601. In one advantageous embodiment, the temperature near the inlet to the HDTA is measured from the HDTA inlet temperature sensor 38. Further, step 1804 may compare a plurality of temperature measurements from a time series of temperature measurements to the target window of temperatures. If the fuel temperature measurement near the inlet to the HDTA does not lie within the target window of temperatures, then the method 1800 proceeds to step 1806, where the first non-communication fill test 1800 generates a report indicating that the hydrogen dispenser 18 has failed the test, and the second non-communication fill test 1800 ends at step 618 of the HDTA main program 600 (see FIG. 6).

Else, if the fuel temperature measurement near the inlet to the HDTA does lie within the target window of temperatures, then the method 1800 proceeds to step 1808, where the HDTA controller determines if the tank 14 fill pressure is less than a threshold value. The threshold value may be a standard maximum allowable value determined from an industry standard or guideline, such as, for example, SAE TIR J2601, or based on tank design considerations. If the tank 14 fill pressure is not less than the threshold value, then the method 1800 proceeds to step 1806.

If the tank 14 fill pressure is less than the threshold value, then the method 1800 proceeds to step 1810, where the method 1800 determines whether the tank temperature is less than a threshold temperature. In one embodiment of the invention, the threshold temperature in Step 1810 is about 185 degrees Fahrenheit (85 degrees Celsius). If the tank temperature is not less than the threshold temperature, then the method 1800 proceeds to stop 1806.

If the tank temperature is less than the threshold temperature, then the method proceeds to step 1812, where the method 1800 determines if a measured rate of fill complied with a predefined standard. The method 1800 may determine if the measured rate of fill complied with the predefined standard similarly to that previously discussed regarding step 1512 (FIG. 15).

If the method 1800 determines that the measured rate of fill did not comply with the predefined standard, then the method 1800 proceeds to step 1806. Else, if the method 1800 determines that the measured rate of fill did comply with the predefined standard, then the method 1800 proceeds to step 1814, where the second non-communication fill test 1800 generates a report indicating that the hydrogen dispenser 18 has passed the test, and the second non-communication fill test 1800 ends at step 618 of the HDTA main program 600 (see FIG. 6).

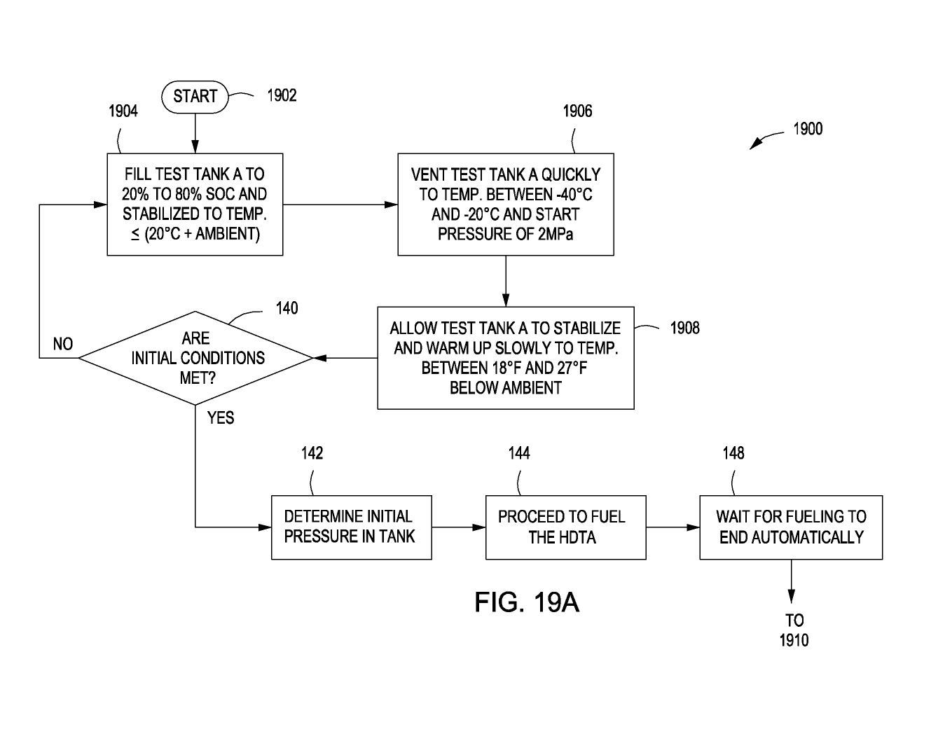

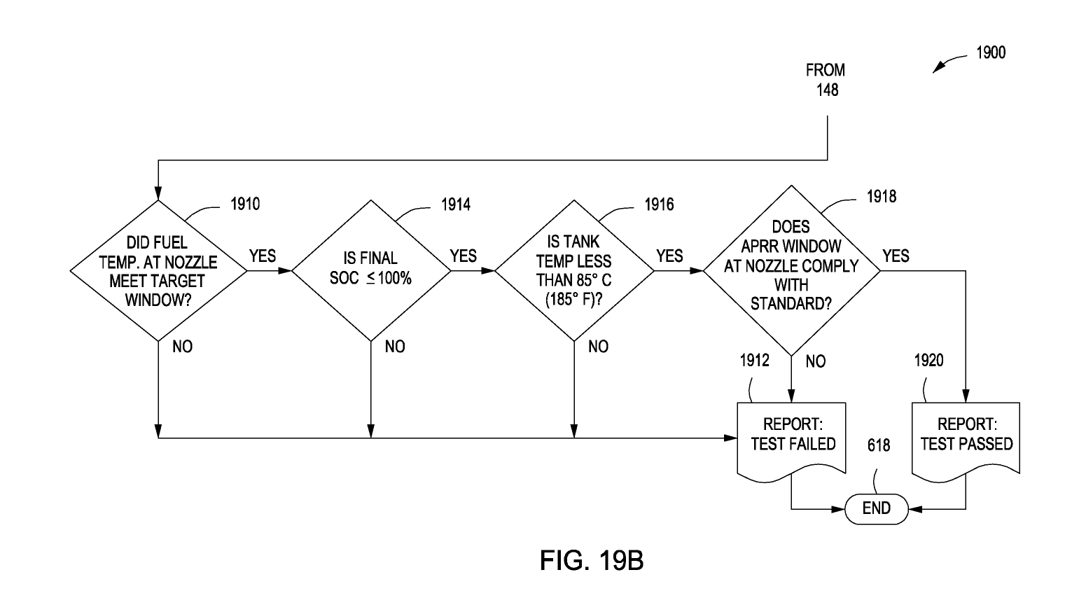

FIG. 19 is a flowchart illustrating steps that may be followed in a cold tank test 1900 of a hydrogen dispenser test apparatus according to an embodiment of the invention. The cold tank test 1900 begins at step 1902, which may be initiated by a user selecting the cold tank test 1900, for example, as part of step 610 of the HDTA main program 600 (see FIG. 6).

In step 1904, the tank 14 is filled with hydrogen to an intermediate value of its rated capacity or state of charge and then allowed to at least partially equilibrate thermally with the ambient environment. In one embodiment, the tank is filled to between about 20% to about 80% its rated capacity or state of charge. In another embodiment, the tank is allowed to thermally equilibrate to within about 36 degrees Fahrenheit (20 degrees Celsius) of the ambient temperature. In step 1904, the tank may be filled with hydrogen using the hydrogen dispenser 18 or other suitable source of pressurized hydrogen.

Next, in step 1906, the tank 14 is rapidly vented in order to decrease the temperature of the contents of the tank. The expansion work performed by the pressurized contents within tank 14 to expel the vented gas acts to decrease the temperature of the contents within the tank 14. In one embodiment of the invention, the tank 14 is vented to achieve a temperature between about −40 degrees Fahrenheit (−40 degrees Celsius) and about −4 degrees Fahrenheit (−20 degrees Celsius), and a pressure of about 290 psig (2 MPa).

Then, in step 1908, the tank 14 is allowed to at least partially equilibrate thermally with the ambient environment. In one embodiment of the invention, the tank 14 is allowed to thermally equilibrate with the ambient environment such that a temperature within the tank 14 is within about 18 degrees Fahrenheit (10 degrees Celsius) and about 27 degrees Fahrenheit (15 degrees Celsius) of the temperature of the ambient environment. If the target test conditions are not satisfied in step 140, the method 1900 repeats steps 1904, 1906, and 1908.

In step 142, an initial pressure of tank 14 is determined by means discussed previously. Then, the hydrogen dispenser 18 proceeds to dispense hydrogen to the HDTA 10 in step 144. Next, in step 148, the method 1900 waits for the fueling of the HDTA 10 by the hydrogen dispenser 18 to end automatically.

In step 1910, the method compares at least one temperature measurement from near the inlet to the HDTA to a target window of temperatures. The target window of temperatures may be defined by an industrial standard or guideline, such as, for example, SAE TIR J2601. In one advantageous embodiment, the temperature near the inlet to the HDTA is measured from HDTA inlet temperature sensor 38. Further, step 1910 may compare a plurality of temperature measurements from a time series of temperature measurements to the target window of temperatures. If the fuel temperature measurement near the inlet to the HDTA does not lie within the target window of temperatures, then the method 1900 proceeds to step 1912, where the cold tank test 1900 generates a report indicating that the hydrogen dispenser 18 has failed the test, and the cold tank test 1900 ends at step 618 of the HDTA main program 600 (see FIG. 6).

Else, if the fuel temperature measurement near the inlet to the HDTA does lie within the target window of temperatures, then the method 1900 proceed to step 1914, where the HDTA controller determines if the final state of charge of the tank is not greater than 100%. If the final state of charge of the tank is greater than 100%, then the method 1900 proceeds to step 1912.

If the final state of charge of the tank is not greater than 100%, then the method 1900 proceeds to step 1916, where the method 1900 determines whether the tank temperature is less than a threshold temperature. In one embodiment of the invention, the threshold temperature in Step 1916 is about 185 degrees Fahrenheit (85 degrees Celsius). If the tank temperature is not less than the threshold temperature, then the method 1900 proceeds to stop 1912.

If the tank temperature is less than the threshold temperature, then the method proceeds to step 1918, where the method 1900 determines if a measured rate of fill complied with a predefined standard. The method 1900 may determine if the measured rate of fill complied with the predefined standard similarly to that previously discussed regarding step 1512 (FIG. 15).

If the method 1900 determines that the measured rate of fill did not comply with the predefined standard, then the method 1900 proceeds to step 1912. Else, if the method 1900 determines that the measured rate of fill did comply with the predefined standard, then the method 1900 proceeds to step 1920, where the cold tank test 1900 generates a report indicating that the hydrogen dispenser 18 has passed the test, and the cold tank test 1900 ends at step 618 of the HDTA main program 600 (see FIG. 6).

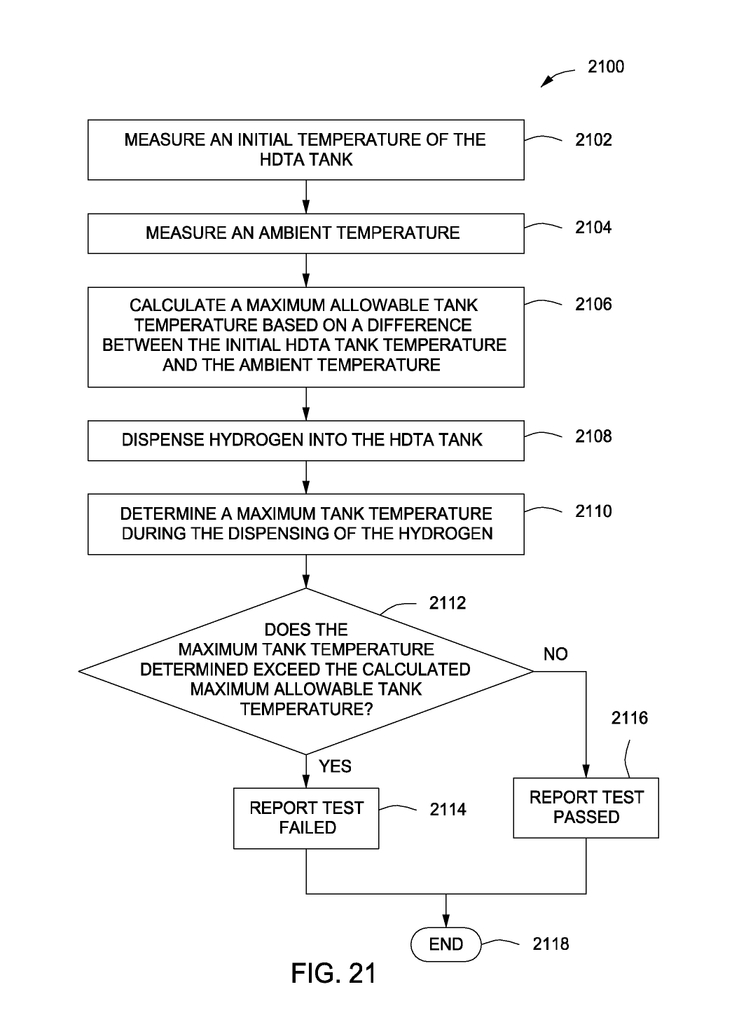

FIG. 21 is a flowchart illustrating steps that may be followed in a tank temperature compliance test 2100 during a filling cycle of a hydrogen dispenser test apparatus according to an embodiment of the invention. In step 2102 an initial temperature of the tank 14 is measured. The initial temperature of the tank 14 may be measured, for example, by the HDTA controller 16 receiving a signal from the tank internal temperature sensor 80 that is indicative of a temperature within the tank 14.

Next, in step 2104, a temperature of the ambient environment surrounding the HDTA 10 is measured. The ambient environment temperature may be measured, for example, by the HDTA controller 16 receiving a signal from the ambient temperature sensor 86 that is indicative of the ambient temperature.

Then, in step 2106, a maximum allowable tank temperature is determined based on a difference between the initial temperature of the tank 14 and the ambient temperature. The HDTA controller 16 may determine the maximum allowable tank temperature based on a calculation, a lookup table, or combinations thereof, for example. In one advantageous embodiment, the HDTA controller 16 determines the maximum allowable tank temperature from the lookup table in Table 1. The relationship between initial tank temperature, ambient temperature, and maximum allowable tank temperature may be based on physics-based simulations, empirical observations, or combinations thereof, for example.

TABLE 1

| | | | | | | | | | |
|---|---|---|---|---|---|---|---|---|---|
| Ambient Temperature − | −9 | −6 | −3 | 0 | 3 | 6 | 9 | 12 | 15 |
| Initial Tank Temperature, ° F. | | | | | | | | | |
| Max. Allowable HDTA | 69 | 71 | 73 | 75 | 77 | 79 | 81 | 83 | 85 |
| Tank Temperature, ° F. | | | | | | | | | |

Next, in step 2108, hydrogen is dispensed into the tank 14 from the hydrogen dispenser 18. Hydrogen may be dispensed into tank 14 from the hydrogen dispenser 18 by the HDTA controller 16 sending signals that cause first supply isolation valve 42 to open, the second supply isolation valve 46 to open, or both isolation valves to open, for example. In one advantageous embodiment, the tank 14 is filled to about 100% state of charge in step 2108. Then, in step 2110, a maximum temperature of the tank during the hydrogen dispensing is determined. The temperature of the tank could be measured from the tank internal temperature sensor 80, the tank external surface temperature sensor 84, or combinations thereof, for example. Further, the maximum temperature of the tank during the hydrogen dispensing may be determined from analysis of a time history of tank temperature measurements by the HDTA controller 16 during the hydrogen dispensing.

In step 2112, the maximum tank temperature during the hydrogen dispensing is compared to the maximum allowable tank temperature. If the maximum tank temperature during the hydrogen dispensing is greater than the maximum allowable tank temperature, then the method 2100 proceeds to step 2114, where a report is generated indicating that the hydrogen dispenser 18 has failed the tank temperature compliance test 2100, and the method 2100 ends at step 2118. Else, if the maximum tank temperature during the hydrogen dispensing is not greater than the maximum allowable tank temperature, then the method 2100 proceeds to step 2116, where a report is generated indicating that the hydrogen dispenser 18 has passed the tank temperature compliance test 2100, and the method 2100 ends at step 2118.

It will be appreciated that other embodiments of the invention may include combinations of tests or combinations of steps from various methods disclosed herein. Further, it will be appreciated that other tests could be performed using the apparatus disclosed herein.

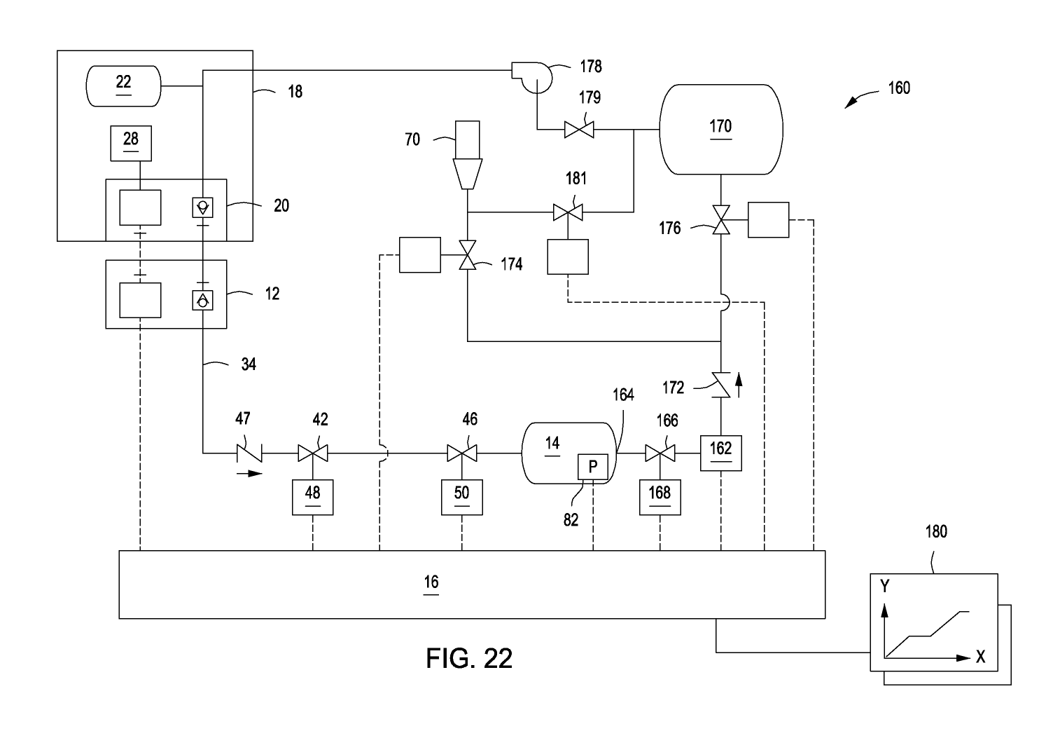

FIG. 22 is a schematic view of a hydrogen dispenser test apparatus 160 according to another embodiment of the invention. The HDTA 160 includes a backpressure control system 162 fluidly coupled to an outlet 164 of the tank 14, and operatively coupled to the controller 16. The backpressure control system 162 includes a variable flow area, which is in fluid communication with the tank 14. The backpressure control system 162 may control the pressure within the tank 14 during a filling procedure from the hydrogen dispenser 18 by varying a flow area of the variable flow area, thereby varying a hydrogen flow out of the tank 14 and into the backpressure control system 162.

An isolation valve 166 may be disposed in a fluid channel between the first tank 14 and the backpressure control system 162. The isolation valve 166 may be operatively coupled to an actuator 168 that is controlled by the controller 16, or alternatively, the isolation valve 166 may be manually actuated.

The backpressure control system 162 may be fluidly coupled to the vent 70, a second tank 170, or both. Further, a check valve 172 may be disposed in a fluid channel between the backpressure control system 162 and the second tank 170, where the check valve 172 is oriented to allow flow only in a direction from the backpressure control system 162 toward the second tank 170. Moreover, valves 174 and 176 may be disposed in fluid channels between the backpressure control system 162 and the vent 70 and the second tank 170, respectively. The valves 174 and 176 could be used to isolate or restrict the flow channel in which each is disposed. Further, either of the valves 174 and 176 may be controlled by the controller 16, or either may be manually actuated.

Methods and apparatus for reproducing the fill characteristics of a variety of tanks using a single HDTA 10 are desired. Indeed, a given hydrogen dispenser 18 may successfully fill some tank designs while failing to successfully fill other tank designs. One way to simulate the fill characteristics of a variety of tanks using a single HDTA 10 would be to include a variety of tanks in the HDTA 10. However, some tank designs occupy large volumes, impart heavy weight, or both, and therefore, including multiple tanks in an HDTA 10 could result in undue apparatus volume or weight. Further, multiple tanks can add undue complexity by necessitating multiple instrumentation and control systems. Moreover, the tank designs in need of testing may evolve with time, and therefore, a multiple tank system may need to frequently incorporate new tanks to reflect new developments in tank designs.

Advantageously, the HDTA 160 may enable simulation of a variety of tank fill profiles 180 by flowing hydrogen from the hydrogen dispenser 18 to the backpressure control system 162 through the tank 14, thereby simulating a time history of tank pressure, tank inlet flow, or both over a filling cycle of a target tank with a larger volume than the first tank 14. Thus, the volume and weight of the tank 14 in the HDTA 160 could be advantageously smaller than the largest target tank to be simulated. In another advantageous embodiment, the volume of the first tank 14 is no smaller than a volume of the smallest target tank to be simulated. In yet another advantageous embodiment, the combined volumes of the first tank 14 and the second tank 170 are at least as large as the volume of the largest target tank to be simulated.

The controller may receive the target tank fill profiles 180 from a user through manual inputs via a user interface such as, for example, a keyboard, a mouse or a touch screen operatively coupled to the controller 16. Further, the controller may receive the target tank fill profiles 180 from machine-readable media, including either transient or non-transient computer readable media, such as, for example, storage disks, USB drives, or a network connection with another computer or processor. The target tank fill profiles 180 may be developed through testing of target tank designs in a lab, or through physics-based simulations of the target tank designs.

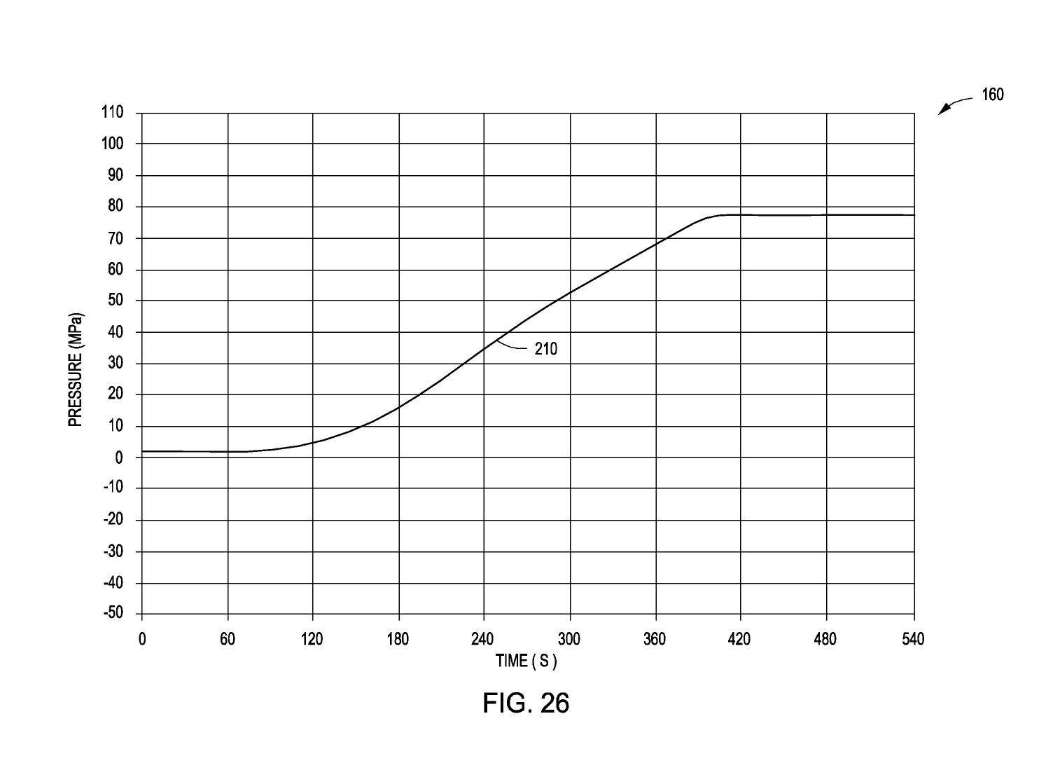

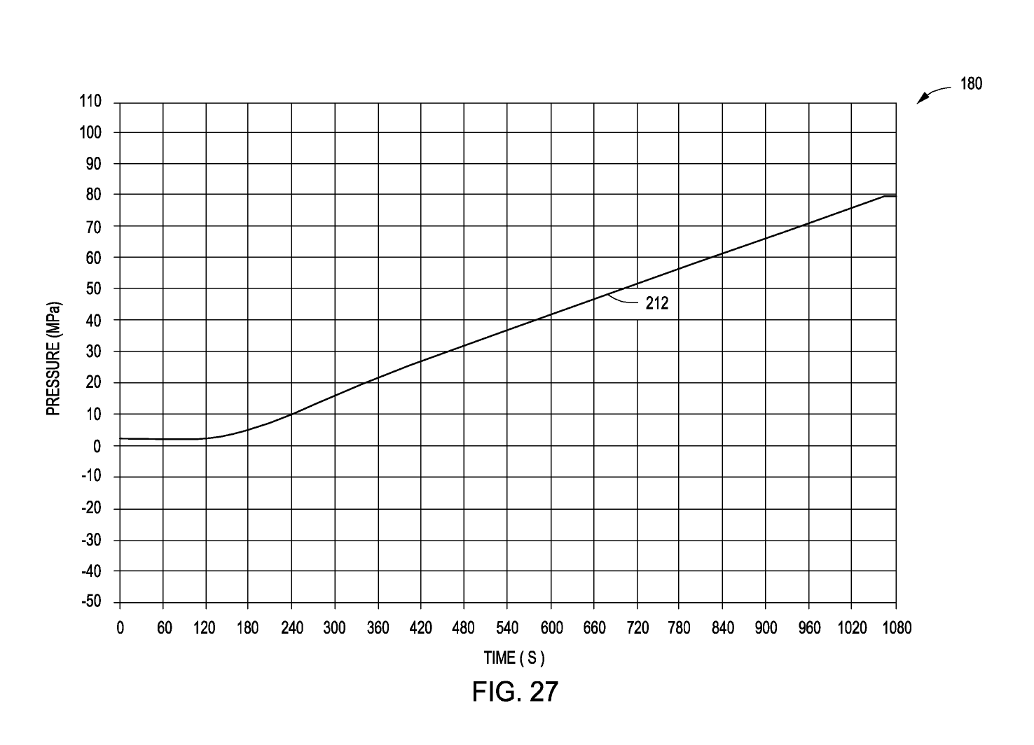

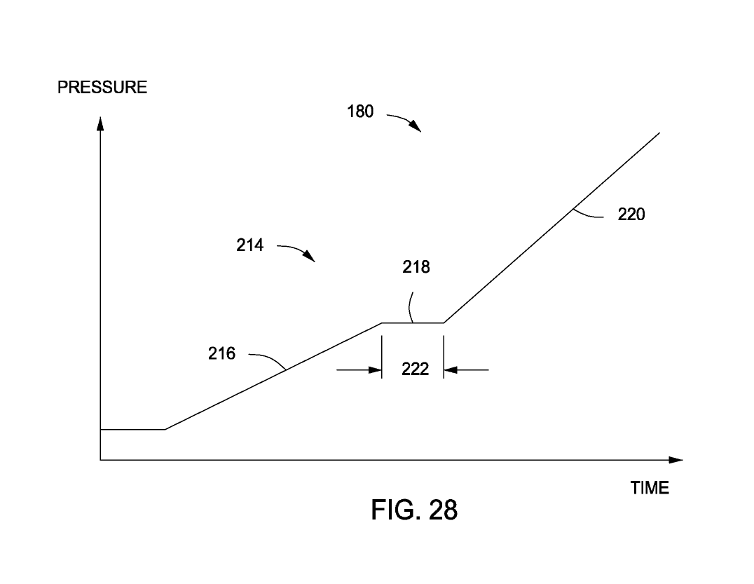

Referring to FIGS. 26-28, it will be appreciated that FIG. 26 illustrates a target tank fill profile 180 according to an embodiment of the invention; FIG. 27 illustrates a target tank fill profile 180 according to another embodiment of the invention; and FIG. 28 illustrates a target tank fill profile 180 according to yet another embodiment of the invention. The target tank profile 180 of FIG. 26 corresponds to a pressure history 210 as a function of time while filling a hydrogen storage tank with a rated volume of 3.9 cubic feet (110 liters) and a rated pressure of 10,100 psi (70 MPa). The target tank profile 180 of FIG. 27 corresponds to a pressure history 212 as a function of time while filling a hydrogen storage tank with a rated volume of 8.8 cubic feet (250 liters) and a rated pressure of 10,100 psi (70 MPa). The pressure histories 210, 212 could include pairings of pressure values and time values, equations describing variation of pressure with time, or combinations thereof.

In FIG. 28, the target tank profile 18 includes a pressure history 214 as a function of time. The pressure history 214 includes a first pressure ramp 216, a hold period 218, and a second pressure ramp 220. During the first pressure ramp 216, a monitored pressure, such as, for example, an internal pressure of a tank being filled, increases at a substantially constant rate as a function of time. During the hold period 218, the pressure is held substantially constant over a time duration 222. Finally, during the second pressure ramp 20, the monitored pressure increases at a substantially constant rate as a function of time. It will be appreciated that the ramp rates during the first pressure ramp 216 and the second pressure ramp 220 could be substantially the same, or alternatively, the ramp rates could be different. Although only two pressure ramps 216, 220 and one hold period 218 are shown in FIG. 28, it will be appreciated that any number of pressure ramps and hold periods could be employed. Further, it will be appreciated that the pressure histories 210, 212, and 214 could include pairings of pressure values and time values, equations describing variation of pressure with time, or combinations thereof.

Referring now to FIG. 22, in one embodiment of the invention, hydrogen flowing through the backpressure control system 162 flows to the vent 70 through the valve 174. In another embodiment of the invention, hydrogen flowing through the backpressure control system 162 flows into the second tank 170 through the check valve 172 and the valve 176. In yet another embodiment of the invention, hydrogen flow through the backpressure control system 162 is split into flows to each of the vent 70 and the second tank 170. The proportion of the flow split between the vent 70 and the second tank 170 may be controlled through actuation of the valve 174, the valve 176, or both. Flowing hydrogen from the backpressure control system 162 into the second tank 170 may advantageously provide better control over the pressure drop across the backpressure control system, as well as enabling reclamation of hydrogen flowing through the backpressure control system 162.

The second tank 170 may be fluidly coupled to the hydrogen storage system 22 through a hydrogen pump 178 and valve 179. In one embodiment of the invention, the hydrogen pump 178 is used to transfer hydrogen from the second tank 170 into the hydrogen storage system 22 of the hydrogen dispenser 18. Further, the second tank 170 may be fluidly coupled to the vent 70 through a valve 181. The valve 181 may be actuated by the controller 16, or alternatively, the valve 181 may be manually actuated.

It will be appreciated that the tank 14, shown in FIG. 22, may have its own internal temperature sensor, internal pressure sensor, external temperature sensor, internal heater, external heater, or pressure relief device as shown for tank 14 in FIG. 1. Moreover, it will be appreciated that the HDTA 156 may incorporate the first bleed channel 52, the second bleed channel 54, the vent channel 68, or any other features shown in FIG. 1.

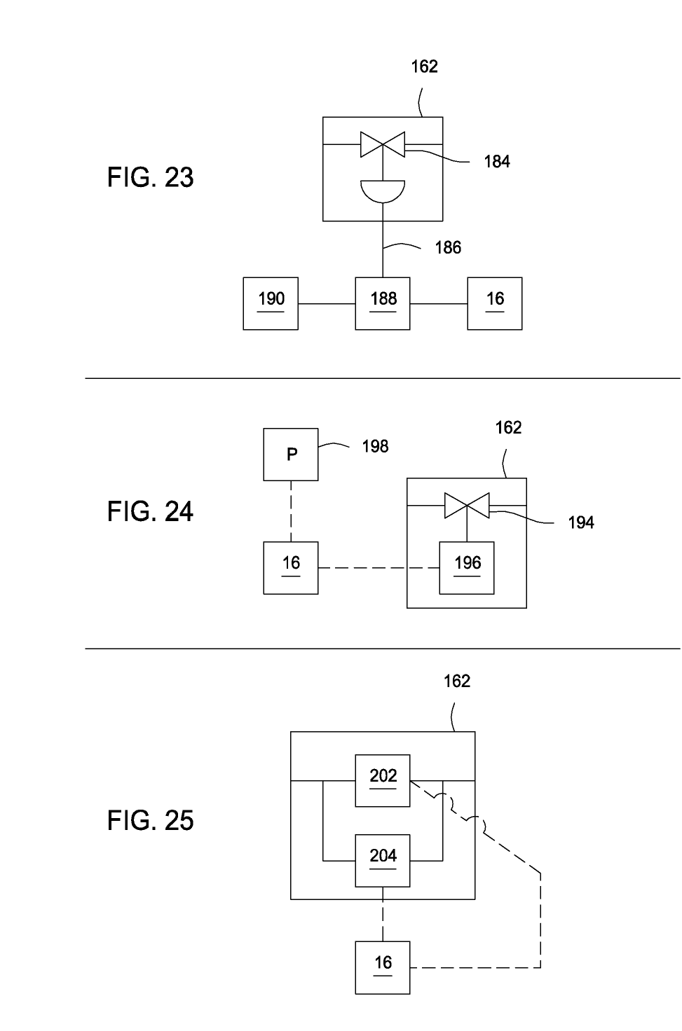

FIG. 23 is a schematic illustrating a backpressure control system 162 according to an embodiment of the invention. The backpressure control system 162 includes at least one backpressure regulator 184 in fluid communication with the first tank 14 and at least one of the vent 70 and the second tank 170, as shown in FIG. 22. The at least one backpressure regulator 184 adjusts a variable flow area therein based on a comparison between a pressure upstream of the variable flow area and a control input 186 from a transducer 188. The transducer 188 may receive a control signal from the controller 16, and may receive power from a power source 190.

In one embodiment of the invention, the transducer 188 converts an electrical signal from the controller 16 into a pneumatic control signal powered by a pneumatic power source 190. In another embodiment of the invention, the transducer 188 converts an electrical signal from the controller 16 into an electrical control signal powered by an electrical power source 190. It will be appreciated that the transducer 188 could be any transducer that transforms one form of energy into another form of energy known to persons having skill in the art.

FIG. 24 is a schematic illustrating a backpressure control system 162 according to another embodiment of the invention. The backpressure control system 162 includes at least one valve 194 in fluid communication with the first tank 14 and at least one of the vent 70 and the second tank 170, as shown in FIG. 22. An actuator 196 adjusts a variable flow area of the valve 194 based on a control signal transmitted to an actuator 196 from the controller 16.

The controller 16 may receive a pressure sensor signal from a pressure sensor and vary the control signal to the valve actuator 196 based on a difference between the pressure sensor signal and a target pressure. Alternatively, the controller may vary the control signal to the valve actuator 196 based on an open loop schedule of control signal magnitude versus another control parameter, such as time, or percentage of fill completion, for example. In one embodiment of the invention, the pressure sensor 198 is the tank internal pressure sensor 82. In another embodiment of the invention, the controller acts to drive a difference between the sensor signal and the target pressure to zero.

FIG. 25 is a schematic illustrating a backpressure control system 162 according to yet another embodiment of the invention. The backpressure control system 162 includes a first backpressure element 202 and a second backpressure element 204, each fluidly coupled to the other in a parallel arrangement. Either of the backpressure elements 202, 204 could be a valve, a backpressure regulator, or other backpressure device known to persons having skill in the art. Further, either of the backpressure elements 202 and 204 could be controlled by the controller 16 by any of the aforementioned methods of controlling a valve or a backpressure regulator. In one embodiment of the invention, the first backpressure element 202 is a backpressure regulator and the second backpressure element 204 is a backpressure valve.

Applicant has identified that control authority of the backpressure control system 162 may benefit from multiple backpressure elements fluidly coupled in a parallel arrangement, thereby extending the range of effective flow areas enabled by the backpressure control system 162. Thus, a range of effective flow areas over which the first backpressure element 202 has control authority may be different from the range of effective flow areas over which the second backpressure element 204 has control authority.

In an embodiment of the invention, the second backpressure element 204 is held closed by the controller 16 while the first backpressure element 202 is modulated in response to a measured value or open loop schedule. In another embodiment of the invention, the second backpressure element 204 is held wide open by the controller 16 while the first backpressure element 202 is modulated in response to a measured value or open loop schedule. In yet another embodiment of the invention, both the second backpressure element 204 and the first backpressure element 202 are simultaneously controlled by the controller 16 at an effective flow area between each backpressure element's wide open flow area and its closed position. Although, only two backpressure elements 202 and 204 are shown in FIG. 25, it will be appreciated that the backpressure control system 162 could include any number of backpressure elements fluidly coupled in a parallel arrangement.

The HDTA controller 16 could be a general purpose computer that is programmed to execute any of the tests, methods, and control actions disclosed herein, a purpose-built processor, or combinations thereof. Further, the HDTA controller 16 could comprise a plurality of networked processors located in the same location or in separate, remote locations. A plurality of processors could be combined to compose the HDTA controller 16 over a wired network, a wireless network, the Internet, or other means for effecting communication between electrical components known to persons having skill in the art.

The HDTA controller 16 is capable of effecting any of the tests or method steps, as well as any of the hardware control functions disclosed herein, including any fill profiles specified in SAE TIR J2601, or the like. For example, the HDTA controller 16 may transmit signals to actuate any hardware components of the HDTA 10, acquire signals from any instrumentation in the HDTA 10; perform logical or mathematical operations on any signals acquired from the HDTA 10, or store raw signal values or calculated values in either volatile or non-volatile memory. However, manual execution of any of the test or method steps is contemplated to be within the scope of the present disclosure.

One embodiment of the invention includes machine-readable instructions encoded on a non-volatile medium, the instructions capable of causing a processor, including but not limited to a processor within the HDTA controller 16, to perform any control operations, tests, or method steps disclosed herein. The non-volatile medium may include magnetic media such as, for example, magnetic computer disks, or optical media such as, for example, CDs or DVDs. Further, the non-volatile medium may include flash memory such as thumb drives or USB drives, or virtual drives accessed via a local area network, the Internet, a computing Cloud, or any other machine-readable non-volatile memory known to persons having skill in the art.

Also, although the apparatus and methods disclosed herein are useful for testing hydrogen dispensers, they can also be used for testing dispensers of other gaseous fuels, such as, natural gas, methane, LP gas, propane, or other gaseous fuels known to persons having skill in the art.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for testing a hydrogen dispenser, comprising:
a first tank;
a supply channel fluidly coupled to the first tank, the supply channel configured to be fluidly coupled to the hydrogen dispenser;
a backpressure system fluidly coupled to the first tank; and
a controller operatively coupled to the backpressure system, the controller configured to:
receive a target fill profile, and
control the backpressure system to effect a fill profile according to the target fill profile.

2. The apparatus according to claim 1, further comprising a second tank fluidly coupled to the backpressure system.

3. The apparatus according to claim 2, wherein an internal volume of the second tank is larger than an internal volume of the first tank.

4. The apparatus according to claim 1, further comprising a vent channel fluidly coupled to the backpressure system and in fluid communication with an ambient environment of the apparatus.

5. The apparatus according to claim 1, wherein the backpressure system includes at least one backpressure regulator in fluid communication with the first tank and the controller.

6. The apparatus according to claim 5, wherein the at least one backpressure regulator consists of a plurality of backpressure regulators.

7. The apparatus according to claim 6, wherein the plurality of backpressure regulators includes a first backpressure regulator and a second backpressure regulator, the first backpressure regulator being fluidly coupled in parallel with the second backpressure regulator.

8. The apparatus according to claim 2, further comprising a hydrogen pump in fluid communication with the second tank and the hydrogen dispenser, the controller being configured to transfer hydrogen from the second tank to the hydrogen dispenser via the hydrogen pump.

9. The apparatus according to claim 2, further comprising a check valve in fluid communication with the backpressure system and the second tank, the check valve being arranged to allow a flow of hydrogen from the backpressure system to the second tank, and block a flow of hydrogen from the second tank to the backpressure system.

10. The apparatus according to claim 1, wherein the fill profile includes a trend of pressure as a function of time.

11. A method for testing a hydrogen dispenser using a test apparatus, the test apparatus including
a first tank,
a supply channel fluidly coupled to the first tank, the supply channel configured to be coupled to the hydrogen dispenser,
a backpressure system fluidly coupled to the first tank, and
a controller operatively coupled to the backpressure system, the method comprising:
receiving a target fill profile via the controller;
dispensing hydrogen from the hydrogen dispenser to the test apparatus through a first valve of the supply channel; and
controlling the backpressure system via the controller to effect a fill profile according to the target fill profile.

12. The method according to claim 11, wherein the controlling the backpressure system via the controller includes venting hydrogen from the backpressure system to an ambient environment of the test apparatus.

13. The method according to claim 11, wherein the controlling the backpressure system via the controller includes transferring hydrogen from the backpressure system to a second tank.

14. The method according to claim 13, wherein the controlling the backpressure system via the controller further includes transferring hydrogen from the second tank to the hydrogen dispenser.

15. The method according to claim 14, wherein the transferring the hydrogen from the second tank to the hydrogen dispenser includes compressing the hydrogen.

16. The method according to claim 15, wherein the transferring the hydrogen from the second tank to the hydrogen dispenser includes storing the hydrogen in a hydrogen storage system of the hydrogen dispenser.

17. The method according to claim 13, further comprising blocking fluid communication between the backpressure system and the second tank and transferring hydrogen from the second tank to the hydrogen dispenser.

18. An article of manufacture, comprising a machine-readable non-volatile medium having instructions encoded thereon for enabling a processor to perform the operations of:
dispensing hydrogen from a hydrogen dispenser to a first tank through a supply channel disposed between the hydrogen dispenser and the first tank;
receiving a target fill profile; and
controlling a backpressure system fluidly coupled to the first tank to effect a fill profile according to the target fill profile.

19. The article of manufacture according to claim 18, wherein the instructions further include effecting fluid communication between the backpressure system and a second tank.

20. The article of manufacture according to claim 19, wherein the instructions further include effecting fluid communication between the backpressure system and an ambient environment of the hydrogen dispenser, thereby venting hydrogen to the ambient environment of the hydrogen dispenser.
